(19) United States
(12) Patent Application Publication
(10) Pub. No.: US 2020/0184583 A1
(43) Pub. Date: Jun. 11, 2020

(54) APPARATUS AND METHODS FOR MARKETING REAL ESTATE ASSETS AND/OR OTHER HIGH VALUE ASSETS

(71) Applicants: RONALD FARLEY RICHARDS, TIBURON, CA (US); RAYMOND ANTHONY JOAO, YONKERS, NY (US)

(72) Inventors: RONALD FARLEY RICHARDS, TIBURON, CA (US); RAYMOND ANTHONY JOAO, YONKERS, NY (US)

(21) Appl. No.: 16/596,352

(22) Filed: Oct. 8, 2019

Related U.S. Application Data
(60) Provisional application No. 62/777,095, filed on Dec. 8, 2018.

(51) Int. Cl. G06Q 50/16; G06F 16/93; G06F 16/9035; H04L 9/06; G06F 16/182

(52) U.S. Cl. CPC G06Q 50/167; G06F 16/94; G06F 16/1824; H04L 9/0637; G06F 16/9035

(57) ABSTRACT

An apparatus, including a database which stores user profiles, real estate asset profiles, or high value asset profiles, a receiver which receives a user request to access a real estate asset profile or high value asset profile; a processor which processes the request; and a transmitter which transmits the real estate asset profile or high value asset profile and contact information for the owner of the real estate asset or high value asset, a governmental entity, broker or agent, service provider, information or analytics provider, or financial institution, to a communication device. The communication device provides or displays an electronic forum or webpage containing the real estate asset profile or high value asset profile and the contact information. The receiver receives, and the apparatus stores, information regarding user's interest or offer to purchase the real estate asset or high value asset or an action or activity of the user.

### RELATED APPLICATIONS

This application claims the benefit of the priority of U.S. Provisional Patent Application Ser. No. 62/777,095, filed Dec. 8, 2018, and entitled “APPARATUS AND METHODS FOR MARKETING REAL ESTATE ASSETS AND/OR OTHER HIGH VALUE ASSETS”, the subject matter and teachings of which are hereby incorporated by reference herein in their entirety.

### FIELD OF THE INVENTION

The present invention pertains to an apparatus and methods for marketing real estate assets and/or other high value assets and, in particular, the present invention pertains to an apparatus and methods for marketing real estate assets and/or other high value assets which provides owners and/or potential purchasers of respective real estates assets and/or other high value assets with information regarding market interest, market value, and/or liquidity, in and/or for real estate assets or other high value assets which are not currently and actively being offered for sale, and/or in and/or for real estate assets or other high value assets which might be offered for sale under limited circumstances.

### BACKGROUND OF THE INVENTION

There is no doubt that the marketplace for real estate assets and/or other high value assets is interesting but fraught with many imperfections. For example, in conventional marketplaces, prospective purchasers of a real estate asset, such as a house, building, or vacant land, are limited in their search to only those houses, buildings, or vacant land, which have been expressly offered for sale by its owner or other authorized person. As and for another example, prospective purchasers are, therefore, limited in their selection to what is only currently and expressly being offered for sale in the marketplace. In the conventional marketplace, owners of houses, buildings, or vacant land, may have no clue as to what the market value of their house, building, or vacant land, is at any time, and/or whether or not there is a market for, and/or interested and/or qualified prospective purchasers for, the same. There can be no doubt that any real estate asset could have a price set by a prospective purchaser which might both surprise its owner and make an owner decide to sell that asset notwithstanding the fact that the owner may have had no interest or intention to sell the asset in the first place.

As a result, the conventional real estate marketplace limits prospective purchasers to the inventory of real estate assets which are only being offered for sale at the time of their search, and limits owners of real estate assets to information regarding market interest and market value for their asset only after they have made the decision and commitment to offer their real estate asset for sale. It is submitted that there is no technology available which can allow a prospective purchaser to search for, and to provide an offer or offers for, or otherwise express interest in, a real estate asset and/or real estate assets which are not currently being offered for sale in the marketplace, and which can also allow an owner of any real estate assets to be notified or informed of or regarding any market interest in, and/or the potential market value of, their real estate asset, at any time and/or when their real estate asset is not being offered for sale, and/or when real estate assets or other high value assets which might be offered for sale only under limited circumstances.

It is also submitted that all of the above-noted problems and challenges for real estate assets can also be found in the markets for any other high value assets such as, for example, but not limited to, high-end automobiles, boats, jewelry, high-end art, high-end clothing, high-end sports and/or hobby items, and/or any other high value asset.

Another problem faced by buyers and seller of real estate assets or other high value assets, of any type or kind, is that information regarding these real estate assets or other high value assets is typically not readily available and/or must be obtained from multiple sources. The resulting need to obtain or research information from multiple sources can be time consuming, expensive, and difficult.

It is submitted that conventional marketplaces simply do not allow real estate asset owners and other owners of high value assets with access to the latest market information regarding interest in, and/or market value for, and/or other information regarding, their respective assets, and that conventional marketplaces simply do not provide prospective purchasers of real estate assets and/or other high value assets with the opportunity to purchase assets not expressly or actively being offered for sale and/or to obtain any information regarding the marketplace and/or the purchasing process for these real estate assets and/or other high value assets.

### SUMMARY OF THE INVENTION

The present invention pertains to an apparatus and methods for marketing real estate assets and/or other high value assets which overcomes the shortfalls of the prior art.

The present invention pertains to an apparatus and methods for marketing real estate assets and/or other high value assets and, in particular, the present invention pertains to an apparatus and methods for marketing real estate assets and/or other high value assets which provides owners and/or potential buyers of respective real estates assets and/or other high value assets with information regarding market interest, market value, and/or liquidity, in and/or for real estate assets or other high value assets which are not currently being offered for sale, and/or when real estate assets or other high value assets which might only be offered for sale under limited circumstances.

The present invention also pertains to an apparatus and methods which can provide both owners and/or potential buyers of respective real estates assets and/or other high value assets with information which enable them to take advantage, in a more efficient manner, of opportunities to sell and/or purchase real estate assets or other high value assets. The present invention can be utilized to market real estate assets and/or any type or kind of high value asset.

The present invention provides a platform via which a prospective purchaser of a real estate asset, or a high value asset of any type or kind, can search for, identify, and/or indicate an interest in purchasing or acquiring, real estate assets and/or high value assets of any type or kind, whether or not the respective real estate assets and/or high value assets are currently being offered for sale.

The apparatus and methods of the present invention can also be utilized, in a number of preferred embodiments, in order to allow prospective renters or lessees to search for, identify, indicate an interest to rent or lease or to obtain information regarding, make an offer to rent or lease, and/or otherwise interact with and/or engage with owners, of real estate assets and/or high value assets.

The present invention also provides a platform via which an owner of, or any individual authorized to sell, a real estate asset, or a high value asset of any type or kind, can obtain information regarding, and/or be notified of, any individual or individuals who are interested in purchasing the real estate asset or a high value asset, whether or not the real estate asset or a high value asset is currently being offered for sale.

The present invention, in the case of real estate assets, can provide information regarding all real estate assets which are the subject of public record, or which are listed in public records, and/or real estate assets which might be otherwise and/or specifically registered with the apparatus of the present invention, whether or not the same is currently being offered for sale. In the case of high value assets, the present invention can provide information regarding all high value assets which are the subject public record, or which are listed in public records, and/or high value assets which might be otherwise and/or specifically registered with the apparatus of the present invention, whether or not the same is currently being offered for sale.

The present invention can also be utilized by an owner of a real estate asset or a high value asset to place the respective real estate asset or high value asset for sale. The present invention can also be utilized by a user or individual who is, or might be, a prospective purchaser, to indicate or register his or her interest in the respective real estate asset or high value asset, whether or not the same is currently for sale, indicate or register his or her interest in the respective real estate asset or high value asset and submit an offer to purchase the same, and/or indicate or register his or her interest in the respective real estate asset or high value asset and request to engage in discussions with the respective owner of the same, and/or actually engage in discussions with the respective owner of the same.

The present invention can be utilized by a prospective purchaser of a real estate asset or any high value asset to search from among real estate assets or high value assets and attempt to purchase from among these real estate assets or high value assets, whether they are currently listed for sale, thereby potentially expanding the prospective purchaser's marketplace, while allowing an owner of a real estate asset or any high value asset to consider purchase offers regardless of whether or not the owner was interested in selling the real estate asset or high value asset. In this regard, an owner of a real estate asset or a high value asset not currently being offered for sale, can be made aware of a market for or regarding his or her real estate asset or high value asset, of which market he or she may never have otherwise become aware.

The present invention can be utilized by a prospective renter or lessee of a real estate asset or any high value asset to search from among real estate assets or high value assets and attempt to rent or lease from among these real estate assets or high value assets, whether they are currently listed for rent, thereby potentially expanding the prospective renter's or lessee's marketplace, while allowing an owner of a real estate asset or any high value asset to consider rental or lease offers regardless of whether or not the owner was interested in renting or leasing the real estate asset or the high value asset. In this regard, an owner of a real estate asset or a high value asset not currently being offered for rent or lease, can be made aware of a rental or leasing market for or regarding his or her real estate asset or high value asset, of which market he or she may never have otherwise become aware.

High value assets, as the term is used herein, can be or can include high-end automobiles, boats, jewelry, high-end art, high-end clothing, high-end sports and/or hobby items, and/or any other high value asset or high value assets. High value assets can also be or can include intellectual property rights, patents, patent applications, licenses involving a patent or a patent application, copyrights, copyright applications, licenses involving a copyright or a copyright application, trademarks, trademark applications, licenses involving a trademark or a trademark application, trade secrets, licenses involving a trade secret, franchises, franchise rights, publicity rights, media rights, art, artwork, art collections, equity positions, ownership rights in businesses, and/or any option or options for or relating any of the herein-described high value assets and/or any real estate, and/or any other asset which can have a value assigned to the same and/or which can be the subject of a sale, license, or transfer.

The apparatus of the present invention includes a central processing computer. The central processing computer can include any number of central processing computers and/or computer systems. In this regard, the central processing computer can be a single computer or server computer or can include a plurality of any number of computers, server computers, or computer systems. The central processing computer can be comprised of one computer or computer system and/or can be comprised of a plurality of computers or computer systems. Any number of central processing computers can be utilized in the apparatus of the present invention.

The central processing computer can be specially programmed and specially configured to provide a marketing platform for real estate assets and/or high value assets of any type or kind. The central processing computer can also be specially programmed and specially configured to provide and/or to perform all of the functionalities described herein as being performed by the apparatus and methods of the present invention. The central processing computer can also have a website or websites associated therewith which can serve as an interface for any of the users, or for any other entities, described herein as using or participating in using the apparatus and methods of the present invention.

The apparatus can also include any number of user communication devices. The user communication device can be utilized by any user, individual, party, or entity, who or which uses the apparatus of the present invention in order to communicate with the central processing computer(s) described herein and/or to communicate with any of the other computers and/or communication devices described herein as being utilized in or with the apparatus of the present invention.

The user communication device can communicate with, and/or can be linked with, the central processing computer(s) and/or any other computers or communication devices described herein, via a wired communication network, a wireless communication network, or via any combination of wired and/or wireless communication networks.

The user communication device can be utilized by any of the herein-described users in order to interface with, and/or interact with, the central processing computer or with any of the other computers and communication devices described herein as being used in or with the apparatus of the present invention.

The user communication device can be a computer, a computer terminal, a terminal device connected to, or associated with, the central processing computer, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The user communication device can also be a server computer, a network computer, or any other computer capable of being utilized in a network.

The user communication device can also include and/or be utilized in conjunction with a network computer or any other computer which can be utilized to send and receive text messages and/or e-mail messages for or on behalf of a user. The network computer can be any computer which can be used in a computer communication network to transmit and/or receive text messages or e-mail messages to and/or from any of the herein-described user communication devices and/or can provide a text message or an e-mail message to the user communication device. The respective network computer or other computer can also automatically transmit or “push” a text message or an e-mail message or e-mail messages to a user communication device as soon as same are received and/or in real-time.

The respective network computer or computer can also serve as a conventional text message server or as an e-mail server which can allow a user to request or “pull” a text message or an e-mail message or e-mail messages to a user communication device when requested by the user or other authorized individual. In this regard, any network computer or other computer, such as one that can receive and send text messages or email messages to a user communication device can also be considered to be a user communication device in and of itself. In this regard, a text message server or an e-mail server can also be deemed to be a user communication device. Each user communication device can also have a website or websites associated therewith.

Any number of user communication devices can be utilized in, or in connection with, the apparatus of the present invention. The user communication devices described herein can be utilized to communicate with the central processing computer(s) and/or with any other computers or communication devices described herein in a bi-directional manner.

The apparatus of the present invention can also include a governmental entity computer which can be used by, and/or which can be associated with, a governmental entity which can, for example, be a national government, federal government, regional government, state government, provincial government, local government, municipal government, or any other government of any political subdivision or geographical subdivision. The governmental entity computer can be utilized by any governmental entity which maintains records and/or information regarding real estate assets and/or any other high value assets in, within, or under, its jurisdiction. The governmental entity computer can be utilized by any governmental entity which maintains tax records and/or related information regarding real estate assets and/or any other high value assets in, within, or under, its jurisdiction.

The governmental entity computer can also be utilized to allow the governmental entity, or an employee or agent of same, to communicate with and/or interact with the central processing computer(s), the user communication devices, and/or with any of the other computers and communication devices described herein as being utilized in or with the apparatus of the present invention. The governmental entity computer can communicate with, and/or can be linked with, the central processing computer(s) and/or any other computer or communication devices described herein, via a wired communication network, a wireless communication network, or via any combination of wired and/or wireless communication networks.

The governmental entity computer can be used by its respective governmental entity for any purpose. The governmental entity computer can also be utilized by any of the herein-described governmental entities in order to interface with, and/or interact with, the central processing computer or with any other computers and communication devices described herein as being used in or with the apparatus of the present invention. Each governmental entity computer can include any number of computers, server computers, or computer systems. Each governmental entity computer can also have a website or websites associated therewith.

The apparatus of the present invention can also include a broker/agent communication device which can be used by, and/or which can be associated with, a real estate broker and/or agent and/or any broker or agent who or which engages in facilitating transaction involving any high value asset or high valued assets. The broker/agent communication device can be utilized to allow the respective broker or agent, or an employee or agent of same, to communicate with and/or interact with the central processing computer(s), the user communication devices, the governmental entity computers, and/or with any of the other computers and communication devices described herein as being utilized in or with the apparatus of the present invention. The broker/agent communication device can communicate with, and/or can be linked with, the central processing computer(s) and/or any other computer or communication devices described herein, via a wired communication network, a wireless communication network, or via any combination of wired and/or wireless communication networks.

The broker/agent communication device can be used by its respective broker, agent, or employee or agent of same, for any purpose. The broker/agent communication device can also be utilized by any of the herein-described brokers or agents, or employees or agents of same, in order to interface with, and/or interact with, the central processing computer or with any other computers and communication devices described herein as being used in or with the apparatus of the present invention. Each broker/agent communication device can also have a website or websites associated therewith.

The broker/agent communication device can be a computer, a computer terminal, a terminal device connected to, or associated with, the central processing computer, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The broker/agent communication device can also be a server computer, a network computer, or any other computer capable of being utilized in a network.

The apparatus can also include a service provider communication device which can be used by, and/or which can be associated with, any person or entity who or which can provide a service to or for any of the owners and/or prospective purchasers of any of the herein-described real estate assets and/or high value assets. A service provider can be any provider of any good or service which can be the subject of any type or kind of commerce. For example, service providers can be any individuals and/or entities who or which can provide any type or kind of good or service for any owners and/or prospective purchasers of any of the herein-described real estate assets and/or high value assets. In this regard, service providers can, for example, include, any type or kind of attorneys, agents, brokers, marketing professional, finance professionals, construction professionals, architectural professions, appraisers, engineers, inspector, pest control professional, insurance professionals, title insurance professionals, repair professional, rehabilitation professionals, interior and/or exterior decorating professions, and/or any other providers of any goods and/or services which may be of interest to any of the herein-described owners and/or prospective purchasers of any of the herein-described real estate assets and/or high value assets.

The service provider communication device can be utilized to allow the service provider, or an employee or agent of same, to communicate with and/or interact with the central processing computer(s), the user communication devices, the governmental entity computers, the broker/agent communication devices, and/or with any of the other computers and communication devices described herein as being utilized in or with the apparatus of the present invention. The service provider communication device can communicate with, and/or can be linked with, the central processing computer(s) and/or any other computer or communication devices described herein, via a wired communication network, a wireless communication network, or via any combination of wired and/or wireless communication networks.

The service provider communication device can be used by its respective service provider, or employee or agent of same, for any purpose. The service provider communication device can be utilized by any of the herein-described service providers, or employees or agents of same, in order to interface with, and/or interact with, the central processing computer or with any other computers and communication devices described herein as being used in or with the apparatus of the present invention. Each service provider communication device can also have a web site or web sites associated therewith.

The service provider communication device can be a computer, a computer terminal, a terminal device connected to, or associated with, the central processing computer, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The service provider communication device can also be a server computer, a network computer, or any other computer capable of being utilized in a network.

The apparatus of the present invention can also include an information/analytics provider computer which can be used by, and/or which can be associated with, any person or entity who or which can provide analytics information, valuation information, and/or any news and/or other information, which may be deemed useful or desirable by or to any of the owners and/or prospective purchasers of any of the herein-described real estate assets and/or high value assets.

The information/analytics provider computer can be utilized to allow the provider of the respective information and/or analytics data and/or information, or an employee or agent of same, to communicate with and/or interact with the central processing computer(s), the user communication devices, the governmental entity computers, the broker/agent communication devices, the service provider communication devices, and/or with any of the other computers and communication devices described herein as being utilized in or with the apparatus of the present invention. The information/analytics provider computer can communicate with, and/or can be linked with, the central processing computer(s) and/or any other computer or communication devices described herein, via a wired communication network, a wireless communication network, or via any combination of wired and/or wireless communication networks.

The information/analytics provider computer can be used by its respective information and/or analytics provider, or employee or agent of same, for any purpose. The information/analytics provider computer can also be utilized by any of the herein-described information and/or analytics providers, or employee or agent of same, in order to interface with, and/or interact with, the central processing computer or with any other computers and communication devices described herein as being used in or with the apparatus of the present invention. Each information/analytics provider computer can also have a website or websites associated therewith.

The information/analytics provider computer can be a computer, a computer terminal, a terminal device connected to, or associated with, the central processing computer, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The information and/or analytics provider, or employee or agent of same, can also be a server computer, a network computer, or any other computer capable of being utilized in a network.

The apparatus can also include a financial institution computer which can be used by, and/or which can be associated with, any financial institution, financial intermediary, or any provider of financial products and/or services.

The financial institution computer can be utilized to allow the financial institution, financial intermediary, or any provider of financial products and/or services, or an employee or agent of same, to communicate with and/or interact with the central processing computer(s), the user communication devices, the governmental entity computers, the broker/agent communication devices, the service provider communication devices, the information/analytics provider computer, and/or with any of the other computers and communication devices described herein as being utilized in or with the apparatus of the present invention. The financial institution computer can communicate with, and/or can be linked with, the central processing computer(s) and/or any other computer or communication devices described herein, via a wired communication network, a wireless communication network, or via any combination of wired and/or wireless communication networks.

The financial institution computer can be used by its respective financial institution, financial intermediary, or any provider of financial products and/or services, or employee or agent of same, for any purpose. The financial institution computer can be utilized by any of the herein-described financial institutions, financial intermediaries, or any providers of financial products and/or services, in order to interface with, and/or interact with, the central processing computer or with any other computers and communication devices described herein as being used in or with the apparatus of the present invention. Each financial institution computer can also have a website or websites associated therewith.

The financial institution computer can be a computer, a computer terminal, a terminal device connected to, or associated with, the central processing computer, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The financial institution computer can also be a server computer, a network computer, or any other computer capable of being utilized in a network.

Any number of central processing computers, user communication devices, governmental entity computers, broker/agent communication devices, service provider communication devices, information/analytics provider computers, and financial institution computers, can be utilized in, and/or in connection with or in association with, the apparatus of the present invention.

Any of the central processing computers, the user communication devices, the governmental entity computers, the broker/agent communication devices, the service provider communication devices, the information/analytics provider computers, and/or the financial institution computers, can communicate with any other central processing computer(s), user communication device(s), governmental entity computer(s), the broker/agent communication device(s), the service provider communication device(s), the information/analytics provider computer(s), and/or the financial institution computer(s), in a bi-directional manner. In this regard, any computer or communication device described herein can communicate, in a bi-directional manner, with any other computer or communication device regardless of whether the respective computer or communication device is a central processing computer, a user communication device, a governmental entity computer, a broker/agent communication device, a service provider communication device, an information/analytics provider computer, and/or a financial institution computer.

The apparatus and methods of the present invention can be utilized on, over, or via, the Internet and/or the World Wide Web. The apparatus and methods of the present invention can also be utilized over any suitable communication network and/or any combination of computer networks, including, but not limited to the Internet, the World Wide Web, a telecommunication network or system, a telephone network or system, a cable television communication network or system, a satellite television communication network or system, a digital television network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video and communication network or system, a streaming audio communication network or system, a live video communication network or system, and/or any other suitable communications network or system, and/or any combination(s) thereof.

The central processing computer can include a central processing unit (CPU), a random access memory (RAM) device, a read only memory (ROM) device, a user input device, a display device, an output device, a receiver, a database, a transmitter, a global positioning device, and/or a camera and/or a video recording device.

Each of the herein-described user communication devices, governmental entity computers, broker/agent computer or communication devices, service provider communication devices, information/analytics provider computers, and/or financial institution computers, can include a central processing unit or CPU, a random access memory (RAM) device, a read only (ROM) memory device, a user input device, a display device, a transmitter, a receiver, a database, an output device, a video and/or audio recording device(s), and/or a global positioning device.

The present invention can be utilized to allow any user to search for, express an interest, and/or seek to purchase, any real estate asset of public record, any real estate asset listed as being offered for sale or being available for sale, any high value asset of any type or kind which is of public record, and/or any high value asset listed as being offered for sale or being available for sale. The present invention can also be utilized to allow any owner of any real estate asset of public record, any real estate asset listed as being offered for sale or being available for sale, any high value asset of any type or kind which is of public record, and/or any high value asset listed as being offered for sale or being available for sale, to obtain and/or to be provided with information regarding users or prospective purchasers who are or may be interested in purchasing their respective real estate asset or high value asset, and/or any offers to purchase their respective real estate asset or high value asset.

Any and/or all users of the present invention, can each create a user profile which can be stored in the database of the central processing computer. Users can include owners of any of the herein-described real estate assets and/or owners of any of the herein-described high value assets. Each real estate asset can have a real estate asset profile associated therewith or assigned thereto and each high value asset can have a high value asset profile associated therewith or assigned thereto. The user profiles, real estate profiles, and high value asset profiles, can be stored in the central processing computer.

Each user profile can contain and/or include information regarding the name, address, email address, telephone number, cellular telephone number, a text messaging number, an SMS messaging number, an instant messaging ID, a picture or photograph of the user, a description or biographical information by the user, any occupation information, if desired, any information regarding interests or hobbies, if desired, and/or any other information which the user wants to add about himself, herself, or itself, any video conferencing ID information such, for example, but not limited to any video conferencing service or application and/or any videoconferencing services or applications and/or any video chatting services or applications. The user profile can also contain a link of hyperlink to and/or for allowing any other user or owner to call, send an email to, send a text message, an SMS message, or an instant message, to, text message, and/or initiate a video conference with, and/or to communicate with or send a message to, the user via the user's user profile.

A user can also specify, in instances when the user may be a prospective purchaser, they he, she, or it, is pre-certified or pre-authorized to obtain a mortgage to purchase a real estate asset or a loan for a high value asset. The user, in instances when the user may be a prospective purchaser, can also request to receive an alert message or a notification message if and when a real estate asset in a certain location is offered for sale, or if another user makes an offer to purchase a real estate asset the user may have indicated that he, she, or it, is interested in purchasing regardless of whether the real estate asset is currently being offered for sale, and/or upon the occurrence of any other specified event.

A user, in instances when the user may be a prospective purchaser, can also request to receive an alert message or a notification message if and when a high value asset is offered for sale, or if another user makes an offer to purchase a high value asset that the user may have indicated that he, she, or it, is interested in purchasing regardless of whether the high value asset is currently being offered for sale, and/or upon the occurrence of any other specified event.

A user can also specify, in instances when the user may be an owner of a real estate asset or of a high value asset, to receive an alert message or a notification message if and when another user, who may be a prospective purchaser, has indicated or registered an interest in purchasing a real estate asset in a price range in which the owner may be interested in selling his, her, or its, real estate asset and/or that another user, who may be a prospective purchaser, has indicated or registered an interest in purchasing a high value asset in a price range in which the owner may be interested in selling his, her, or its, high value asset. The user can also specify, in instances when the user may be an owner of a real estate asset or a high value asset that he, she, or it, receive an alert message or a notification message upon the occurrence of other pre-specified event.

The user profile can be created, edited, and/or updated, at any time by the user or a person authorized by the user. Any data and/or information contained in, and any and/or all, user profiles described herein can be stored in the central processing computer or in any other computer or communication device utilized in connection with the present invention.

A real estate asset profile can contain information regarding a description of the real estate asset, the address of the real estate asset, the municipality of the real estate asset, the record owner of the real estate asset, annual property taxes for the real estate asset, price history of past transactions of the real estate asset, property tax history for the real estate asset, any survey of or for the real estate asset, layout or floor plan, any blueprints for any building(s) situated on the real estate asset, zoning information, certificate of occupancy or certificates of occupancy, any permit applications, any permits, any offering prices and/or offering terms, if already listed for sale, a photograph or more than one photographs of the real estate asset, a video presentation, a virtual tour, a 3-dimensional (3D) video presentation, a 3D virtual tour, a virtual reality (VR) video presentation, a VR virtual tour, an augmented reality (AR) video presentation, and/or an AR virtual tour, and/or any link and/or hyperlink to same, for the real estate asset, and/or any other information regarding the real estate asset that a prospective purchaser might be interested in when considering to purchase the real estate asset, and/or any link and/or hyperlink to same, and/or any information regarding the real estate asset that an owner may want or need to provide when attempting to sell a real estate asset, and/or any links and/or hyperlinks to same.

The real estate asset profile can also include information regarding whether or not the real estate asset is currently being offered for sale, the name(s) of any user or users who have indicated an interest in the real estate asset if it is currently being offered for sale, along with information regarding the amount of any purchase offer for the real estate asset made by any user or users, and the name(s) of any user or users who have indicated an interest in the real estate asset even if it is not currently being offered for sale, along with information regarding the amount of any purchase offer for the real estate asset made by any user or users.

With regards to a residential real estate asset, the real estate asset profile can also contain information regarding square footage of a house, number of bedrooms, number of bathrooms, a basement, an attic, a garage, improvements, recent improvements, additions, renovations, type of heating, type of air conditioning, estimates fuel costs, estimated heating costs, estimated utilities costs, rent roll, if a multi-family dwelling, and/or any other information which can be required or desired to provide and/or to advertise when selling a residential real estate asset, and/or any links and/or hyperlinks to same.

With regards to a commercial real estate asset, the real estate asset profile can also contain information regarding square footage of the same, a basement, an attic, a garage, improvements, recent improvements, additions, renovations, type of heating, type of air conditioning, estimates fuel costs, estimated heating costs, estimated utilities costs, rent roll, and/or any other information which can be required or desired to provide and/or to advertise when selling a commercial real estate asset, and/or any links and/or hyperlinks to same.

An owner of a real estate asset can, at any time, add and/or edit information regarding his, her, or its, real estate asset. A real estate asset profile can be automatically created for each real estate asset, containing at least minimal information regarding the real estate asset, in the first instance. The owner of the real estate asset can then register as the owner of the same and, thereafter, add information to, and/or edit information in, the real estate asset profile at any time. The owner can also add information regarding his, her, or its, real estate asset as well as upload documents such as copies of blueprints, floor plans, surveys, certificates of occupancy, building permits, appraisals, inspection reports, title searches, deeds, titles, contracts, and/or any other document(s) which may be of interest in marketing and/or selling the real estate asset.

The real estate profile can also contain information regarding any and/or all users and/or prospective purchasers who have indicated or registered an interest in purchasing the real estate asset and/or an offer price the individual would be interested in paying for, or offering to purchase, the real estate asset. The real estate asset profile can contain information and/or information sections which can be entered and/or updated by any user. For example, any user can enter information regarding his or her interest in a real estate asset and/or can enter information regarding an offer to purchase, and/or an amount of a purchase offer, into the real estate asset profile. The central processing computer can store information for or regarding any and/or all of the herein-described real estate asset profiles.

A high value asset profile can contain information regarding a description of the high value asset, the owner of the high value asset, the address of the owner of the high value asset, the record owner of the high value asset, price history of past transactions of the high value asset, any offering prices and/or offering terms, if already listed for sale, a photograph or more than one photographs of the high value asset, a video presentation, a virtual tour, a 3-dimensional (3D) video presentation, a 3D virtual tour, a virtual reality (VR) video presentation, a VR virtual tour, an augmented reality (AR) video presentation, and/or an AR virtual tour, and/or any link and/or hyperlink to same, for the high value asset, and/or any other information regarding the high value asset that a prospective purchaser might be interested in when considering to purchase the high value asset, and/or any link and/or hyperlink to same, and/or any information regarding the high value asset that an owner may want or need to provide when attempting to sell a high value asset, and/or any links and/or hyperlinks to same.

A high value asset profile can also include information regarding whether or not the high value asset is currently being offered for sale, the name(s) of any user or users who have indicated an interest in the high value asset if it is currently being offered for sale, along with information regarding the amount of any purchase offer for the high value asset made by any user or users, and the name(s) of any user or users who have indicated an interest in the high value asset even if it is not currently being offered for sale, and information regarding the amount of any purchase offer for the high value asset made by any user or users.

An owner of a high value asset can, at any time, create a high value asset profile for his, her, or its, high value asset, by registering same with the apparatus of the present invention. The owner of the high value asset can then register as the owner of the same and, thereafter, add information to, and/or edit information in, the high value asset profile at any time. The owner can also add information regarding his, her, or its, high value asset as well as upload pictures and/or video recordings and/or documents such as titles, appraisals, valuations, inspection reports, contracts, and/or any other document(s) which may be of interest in marketing and/or selling the high value asset.

The high value asset profile can also contain information regarding any and/or all users and/or prospective purchasers who have indicated or registered an interest in purchasing the high value asset and/or an offer price the individual would be interested in paying for, or offering to purchase, the high value asset. The owner of the high value asset can thereafter, add information to, and/or edit information in, the high value asset profile at any time. The high value asset profile can contain information and/or information sections which can be entered and/or updated by any user. For example, any user can enter information regarding his or her interest in a high value estate asset and/or can enter information regarding an offer to purchase, and/or an amount of a purchase offer, into the high value asset profile. The central processing computer can store information for or regarding any and/or all of the herein-described high value asset profiles.

The present invention can, in the case of real estate assets, allow a user to search for real estates assets from among any and/or all real estate assets which are of public record, by address, by municipality, by political subdivision, or by zip code. The present invention can also allow a user to search for real estate assets from among any and/or all real state assets, which may or may not be of public record but which are listed for sale, by address, by municipality, by political subdivision, or by zip code. Once a user searches for real estate assets, by municipality, political subdivision, or zip code, the present invention can transmit and/or provide a map of the desired or selected address, municipality, political subdivision, or zip code, to the user communication device being utilized by the user. The map can be displayed via the display device of the user communication device. The map can show any real estate asset of the desired address and/or any and/or all real estate assets of public record and/or which are listed for sale in the desired or selected municipality, political subdivision, or zip code. The map can show all real estate asset plots of real estate and all real estate assets from a top view perspective, can provide a street map or other elevation view of the same, and/or can provide an aerial and/or a satellite view of the same. The user can enlarge, or zoom in, on any real estate asset and/or on any portion or portions of the map. If interested in a real estate asset, the user can select to obtain and/or view information regarding the same.

If the user selects a real estate asset in order to obtain and/or to view information regarding the same, the present invention can provide and/or transmit the real estate asset profile to the user communication device in and/or as part of an electronic forum. The electronic forum can be displayed on and/or via the display device of the user communication device. The electronic forum can provide the user with the real estate asset profile, a link(s) or hyperlink(s) to any of the herein-described contact information of or for the owner of the real estate asset, so that the user can communicate and/or otherwise make contact with the owner of the real estate asset, a link(s) or hyperlink(s) to the governmental entity computer associated with the municipality or political subdivision in which the real estate asset is situated, so that the user can request and/or obtain any desired or needed information of public record for the real estate asset, and a link(s) or hyperlink(s) to a broker/agent communication device associated with a buyer's broker or an buyer's agent, so that the user can communicate with and/or engage the services of the buyer's broker or an buyer's agent for or regarding the real estate asset, and/or a link(s) or hyperlink(s) to a service provider computer(s) associated with any one of more types or kinds of service providers, such as for example, but not limited to an attorney, an inspection engineer, a surveyor, an architect, a tax certiorari professional, a construction company or entity, a home improvement professional or entity, and/or any other service provider who or which can provide any service to the user in order to allow the user to contact and/or communicate with any service provider for any reason.

The electronic forum can also provide the user with a link(s) or hyperlink(s) to the information/analytics provider computer(s) associated with an information/analytics provider(s), so that the user can communicate with an information/analytics provider in order to obtain information and/or analytics information, such as, for example, but not limited to, valuation information regarding the real estate asset, comparable sales prices for the real estate asset, and/or any other data and/or information and/or analytics information which an information/analytics provider can provide to the user, and/or a link(s) or hyperlink(s) to the financial institution computer(s) associated with a financial institution(s), so that the user can communicate with one or more financial institutions to obtain information regarding any products or services offered by the same, and/or for any reason or purpose.

The present invention can also be utilized to allow a user to search for any high value asset or high value assets which are registered with the apparatus of the present invention. The user can search for a high value assets or high valued assets by using any descriptive key word or key words. Once a user searches for high value assets, the apparatus of the present invention will transmit and/or provide a results page to the user communication device being utilized by the user. The results page can be displayed via the display device of the user communication device. The results page can show any value assets which satisfy the search criteria of the user. The user can then select a high value asset listed on the results page.

If the user selects a high value asset in order to obtain and/or to view information regarding the same, the apparatus of the present invention will provide and/or transmit the high value asset profile to the user communication device in and/or as part of an electronic forum. The electronic forum can be displayed on and/or via the display device of the user communication device. The electronic forum can also provide the user with the high value asset profile, a link(s) or hyperlink(s) to any of the herein-described contact information of or for the owner of the high value asset, so that the user can communicate and/or otherwise make contact with the owner of the high value asset.

As with real estate assets, the electronic forum can contain a link(s) or hyperlink(s) to any governmental entity computer associated with any municipality or political subdivision associated with the high value asset, so that the user can request and/or obtain any desired or needed information of public record for the high value asset, a link(s) or hyperlink(s) to a broker/agent communication device associated with a buyer's broker or an buyer's agent, so that the user can communicate with and/or engage the services of the buyer's broker or an buyer's agent for or regarding the high value asset, and/or a link(s) or hyperlink(s) to a service provider computer(s) associated with any one of more types or kinds of service providers who or which might be able to provide a needed or desired service for or regarding the high value asset.

The electronic forum can also provide the user with a link(s) or hyperlink(s) to the information/analytics provider computer(s) associated with an information/analytics provider(s), so that the user can communicate with an information/analytics provider in order to obtain information and/or analytics information regarding the high value asset, and/or a link(s) or hyperlink(s) to the financial institution computer(s) associated with a financial institution(s), so that the user can communicate with one or more financial institutions to obtain information regarding any products or services offered by the same, and/or for any other reason or purpose.

The present invention can be utilized, in a number of applications, in order to allow users and prospective buyers to search for, identify, indicate an interest to purchase or to obtain information regarding, make an offer to purchase, and/or otherwise interact with and/or engage with owners, of real estate assets and/or high value assets.

Any user, who or which can be any natural person, individual, or entity, who or which owns a real estate asset or a high value asset, who or which is a prospective purchaser or a potential purchaser of a real estate asset or a high value asset, and/or who or which may desire to utilize the present invention for any reason or purpose, can utilize the apparatus and methods of the present invention. The user can create a user profile which can include any data and/or information which is described herein as being included in the user profile as well as any other data and/or information which may be needed or required. At any time, any user can also update or edit his, her, or its, user profile.

Any user can utilize the apparatus and methods of the present invention in order to search for a real estate asset or multiple real estate assets and/or to search for a high value asset or multiple high values assets. Upon identifying a respective real estate or high value asset, the user can select to view its respective real estate asset profile or high value asset profile. Thereafter, the user can engage in any action or activity regarding the respective real estate asset or high value asset. These actions or activities can include, but are not limited to, registering or otherwise indicating an interest in the respective real estate or high value asset, making an offer to purchase the respective real estate or high value asset whether or not the respective real estate or high value asset is currently being offered for sale, communicate with the owner of the respective real estate or high value asset, request to be notified if and/or when the respective real estate or high value asset, if not currently being offered fro sale, is offered for sale, request to be notified of the offers of other users who may make an offer to purchase the respective real estate or high value asset, and/or request to be notified if and when the owner of the respective real estate or high value asset updates any information or uploads any documents regarding the respective real estate or high value asset.

The user can also access any one or more of any one or more of the user communication device of any other user and/or the owner of the respective real estate or high value asset, any one or more of the governmental entity computers, any one or more of the broker/agent communication devices, any one or more of the service provider communication devices, any one or more of the information/analytics provider computers, and/or any one or more of the financial institution computers, in order to obtain information from the owner of the respective real estate or high value asset, and/or to request and/or obtain information and/or services from, and/or to request and/or engage any respective services of or from, any of the herein-described governmental entities, brokers or agents, service providers, information/analytics providers, and/or financial institutions. The user can also request information from the central processing computer or the apparatus of the present invention at any time. Thereafter, any alert message(s) or notification message(s) which may be generated based on the user's actions or activities can be generated and/or transmitted to the user communication devices of any and/or all users who or which requested receiving such alert message(s) or notification message(s). Thereafter, the central processing computer can store any and/or all information regarding the user's use of the apparatus of the present invention to view the respective real estate profile or high value asset profile and/or any action or activities undertaken by the user regarding or pertaining to respective real estate asset or real estate asset profile or high value asset or high value asset profile, and/or store information regarding any and/or all alert message(s) or notification message(s) transmitted by the central processing computer.

The user can thereafter select to view another real estate asset profile or high value asset profile or cease using the apparatus of the present invention. If the user the desires to view another real estate asset profile or high value asset profile, then the above-described process can be repeated. If, however, the user decides to cease utilizing the apparatus of the present invention, then the operation of the apparatus can cease.

Any user who is an owner (hereinafter also referred to as “owner/user”) of a real estate asset or multiple real estate assets and/or a high value asset or multiple high values assets can utilize the apparatus and methods of the present invention in order to monitor interest in his, her, or its, respective real estate asset(s) or high value asset(s), provide or upload information to the respective real estate asset profile or high value asset profile, and/or engage in any action or activity regarding his, her, or its, respective real estate asset or real estate asset profile or high value asset or high value asset profile. These actions or activities can include, but are not limited to, updating information in his, her, or its, respective real estate asset profile or high value asset profile, uploading documents, information, and/or video presentations of any type or kind to the respective real estate asset profile or high value asset for retrieval by any other user, and/or communicate with any user or users, request to be notified if and/or when a user or prospective purchaser registers or indicates an interest in, or make an offer to purchase, his, her, or its, respective real estate or high value asset, request to be notified if and/or when a user or prospective purchaser, who is pre-qualified for a loan of a certain amount, registers or indicates an interest in, or make an offer to purchase, his, her, or its, respective real estate or high value asset, request to be notified when any user or prospective purchaser, or any specific user or prospective purchaser views, and/or performs any action or activities regarding or pertaining to, his, her, or its, respective real estate profile or high value asset profile, and/or request to be notified upon the occurrence of any other specified event which may be of interest to the owner or to any user interested in the owner's respective real estate or real estate profile or high value asset or high value asset profile.

The owner/user can also access any one or more of any one or more of the user communication device of any other user, any one or more of the governmental entity computers, any one or more of the broker/agent communication devices, any one or more of the service provider communication devices, any one or more of the information/analytics provider computers, and/or any one or more of the financial institution computers, in order to obtain information from the respective user, governmental entity, broker/agent, service provider, information/analytics provider, and/or financial institution. The owner/user can also request information from the central processing computer at any time. Thereafter, any alert message(s) or notification message(s) which may be generated based on the owner/user actions or activities, can be generated and/or transmitted to the user communication devices of any and/or all users who or which requested receiving such alert message(s) or notification message(s). Thereafter, the central processing computer can store any and/or all information regarding the owner/user's use of the apparatus of the present invention and/or any action or activity taken by the owner/user regarding or pertaining to his, her, or its, respective real estate asset or real estate asset profile or high value asset or high value asset profile, and/or store information regarding any and/or all alert message(s) or notification message(s) transmitted by the central processing computer.

The present invention can be utilized in order to allow any user to search for and/or identify any real estate asset and/or any high value asset, whether or not the same is currently being offered for sale, and take any step or perform any action or activity in seeking to purchase the same. The present invention can also be used to allow a user to expand his or her universe of real estate assets and/or high value assets from among which he or she may be able to shop and/or effectuate a purchase while, at the same time, providing an owner of a real estate asset or a high value asset with information regarding current market demand, and/or current market value, for his, her, or its, real estate asset or a high value asset.

Any electronic forums and/or real estate asset profiles and/or high value asset profiles, described herein, can provide any user and/or with any and/or all information and/or contact information needed, required, or desired, for allowing the user to search for, and to make a fully informed decision when seeking to purchase a real estate asset or a high value asset. Any electronic forums and/or real estate asset profiles and/or high value asset profiles, described herein, can also provide any owner of any real estate asset or high value asset with any and/or all information and/or contact information needed, required, or desired, for allowing the owner to make a fully informed decision when deciding whether or not to sell a real estate asset or a high value asset.

The present invention overcomes a number of shortfalls in conventional systems for selling and/or marketing real estate assets and/or high value assets and represent as substantial technological improvement over conventional systems. The present invention can provide an owner of a real estate asset or a high value asset with information regarding any interest by a prospective purchaser to purchase the same at any time and regardless of whether or not the owner's real estate asset or high value asset is currently listed, or is currently being offered, for sale. In this regard, the present invention can provide an owner of a real estate asset or a high value asset with current information regarding the demand and/or market value for his or her real estate asset or high value asset at any time.

The present invention can also be utilized to provide any user or prospective purchaser of a real estate asset or a high value asset with the opportunity to express interest in purchasing, and/or make an offer to purchase, any real estate asset or a high value asset regardless of whether or not the real estate asset or high value asset is currently listed, or is currently being offered for sale. In this regard, the present invention can also provide a user or prospective purchaser of a real estate asset or a high value asset with a larger universe of real estate assets or high value assets from which to choose when making purchasing decisions.

Any data and/or information and/or any transactions or communications, for, regarding, relating, or pertaining, to any of the herein-described user profiles, real estate asset profiles, and/or high value asset profiles, and/or any offers made by any users for any real estate assets and/or any high value assets, and/or any other information and/or communications, including contracts for sale for any of the herein-described real estate assets and/or high value assets and/or any documents relating or pertaining to any of the herein-described real estate assets and/or high value assets, can be processed and/or stored using a distributed ledger and blockchain technology or blockchain technologies.

The present invention can also be utilized to facilitate the rental or leasing of any of the herein-described real estate assets and/or high value assets. In this manner, users can seek to rent or lease a real estate asset or a high value asset which may not be currently listed for rental or listed as being available for a lease, while also allowing an owner of a real estate asset or a high value asset to be apprised of an interest by a user or users to rent or lease his or her real estate asset or a high value asset and/or any market demand relating to the same.

### BRIEF DESCRIPTION OF THE DRAWINGS

In the Drawings:

FIG. 1 illustrates a preferred embodiment of the apparatus of the present invention, in block diagram form;

FIG. 2 illustrates the central processing computer of FIG. 1, in block diagram form;

FIG. 3 illustrates the user communication device of FIG. 1, in block diagram form;

FIG. 4 illustrates the governmental entity computer of FIG. 1, in block diagram form;

FIG. 5 illustrates the broker/agent communication device of FIG. 1, in block diagram form;

FIG. 6 illustrates the service provider communication device of FIG. 1, in block diagram form;

FIG. 7 illustrates the information and/or analytics provider computer of FIG. 1, in block diagram form;

FIG. 8 illustrates the financial institution computer of FIG. 1, in block diagram form;

FIG. 9 illustrates a preferred embodiment method for utilizing the apparatus of FIG. 1, in flow diagram form;

FIGS. 10A and 10B illustrate another preferred embodiment method for utilizing the apparatus and methods of the present invention, in flow diagram form; and

FIGS. 11A and 11B illustrate another preferred embodiment method for utilizing the apparatus and methods of the present invention, in flow diagram form.

### DESCRIPTION OF THE PREFERRED EMBODIMENTS

The present invention pertains to an apparatus and methods for marketing real estate assets and/or other high value assets and, in particular, the present invention pertains to an apparatus and methods for marketing real estate assets and/or other high value assets which provides owners and/or potential buyers of respective real estates assets and/or other high value assets with information regarding market interest, market value, and/or liquidity, in and/or for real estate assets or other high value assets which are not currently being offered for sale, and/or when real estate assets or other high value assets which might only be offered for sale under limited circumstances.

The present invention also pertains to an apparatus and methods which can provide both owners and/or potential buyers of respective real estates assets and/or other high value assets with information which enable them to take advantage, in a more efficient manner, of opportunities to sell and/or purchase real estate assets or other high value assets. The present invention can be utilized to market real estate assets and/or any type or kind of high value asset.

The apparatus of the present invention provides a platform via which a prospective purchaser of a real estate asset, or a high value asset of any type or kind, can search for, identify, and/or indicate an interest in purchasing or acquiring, real estate assets and/or high value assets of any type or kind, whether or not the respective real estate assets and/or high value assets are currently being offered for sale.

The apparatus of the present invention also provides a platform via which an owner of, or any individual authorized to sell, a real estate asset, or a high value asset of any type or kind, can obtain information regarding, and/or be notified of, any individual or individuals who are interested in purchasing the real estate asset or a high value asset, whether or not the real estate asset or a high value asset is currently being offered for sale.

The apparatus of the present invention, in the case of real estate assets, can provide information regarding all real estate assets which are the subject of public record, or which are listed in public records, and/or real estate assets which might be otherwise and/or specifically registered with the apparatus of the present invention, whether or not the same is currently being offered for sale. In the case of high value assets, the present invention can provide information regarding all high value assets which are the subject public record, or which are listed in public records, and/or high value assets which might be otherwise and/or specifically registered with the apparatus of the present invention, whether or not the same is currently being offered for sale.

The apparatus of the present invention can also be utilized by an owner of a real estate asset or a high value asset to place the respective real estate asset or high value asset for sale. The present invention can also be utilized by a user or individual who is, or might be, a prospective purchaser, to indicate or register his or her interest in the respective real estate asset or high value asset, whether or not the same is currently for sale, indicate or register his or her interest in the respective real estate asset or high value asset and submit an offer to purchase the same, and/or indicate or register his or her interest in the respective real estate asset or high value asset and request to engage in discussions with the respective owner of the same, and/or actually engage in discussions with the respective owner of the same.

The apparatus of the present invention can be utilized by a prospective purchaser of a real estate asset or any high value asset to search from among real estate assets or high value assets and attempt to purchase from among these real estate assets or high value assets, whether they are currently listed for sale, thereby potentially expanding the prospective purchaser's marketplace, while allowing an owner of a real estate asset or any high value asset to consider purchase offers regardless of whether or not the owner was interested in selling the real estate asset or high value asset. In this regard, an owner of a real estate asset or a high value asset not currently being offered for sale, can be made aware of a market for or regarding his or her real estate asset or high value asset, of which market he or she may never have otherwise become aware.

The apparatus of the present invention can be utilized by a prospective renter or lessee of a real estate asset or any high value asset to search from among real estate assets or high value assets and attempt to rent or lease from among these real estate assets or high value assets, whether they are currently listed for rent, thereby potentially expanding the prospective renter's or lessee's marketplace, while allowing an owner of a real estate asset or any high value asset to consider rental or lease offers regardless of whether or not the owner was interested in renting or leasing the real estate asset or the high value asset. In this regard, an owner of a real estate asset or a high value asset not currently being offered for rent or lease, can be made aware of a rental or leasing market for or regarding his or her real estate asset or high value asset, of which market he or she may never have otherwise become aware.

High value assets, as the term is used herein, can be or can include high-end automobiles, boats, jewelry, high-end art, high-end clothing, high-end sports and/or hobby items, and/or any other high value asset or high value assets. High value assets can also be or can include intellectual property rights, patents, patent applications, licenses involving a patent or a patent application, copyrights, copyright applications, licenses involving a copyright or a copyright application, trademarks, trademark applications, licenses involving a trademark or a trademark application, trade secrets, licenses involving a trade secret, franchises, franchise rights, publicity rights, media rights, art, artwork, art collections, equity positions, ownership rights in businesses, and/or any option or options for or relating any of the herein-described high value assets and/or any real estate, and/or any other asset which can have a value assigned to the same and/or which can be the subject of a sale, license, or transfer.

Applicant hereby incorporates by reference herein the subject matter and teachings of U.S. Provisional Patent Application Ser. No. 62/777,095, filed Dec. 8, 2018, and entitled “APPARATUS AND METHODS FOR MARKETING REAL ESTATE ASSETS AND/OR OTHER HIGH VALUE ASSETS”, the subject matter and teachings of which are hereby incorporated by reference herein in their entirety.

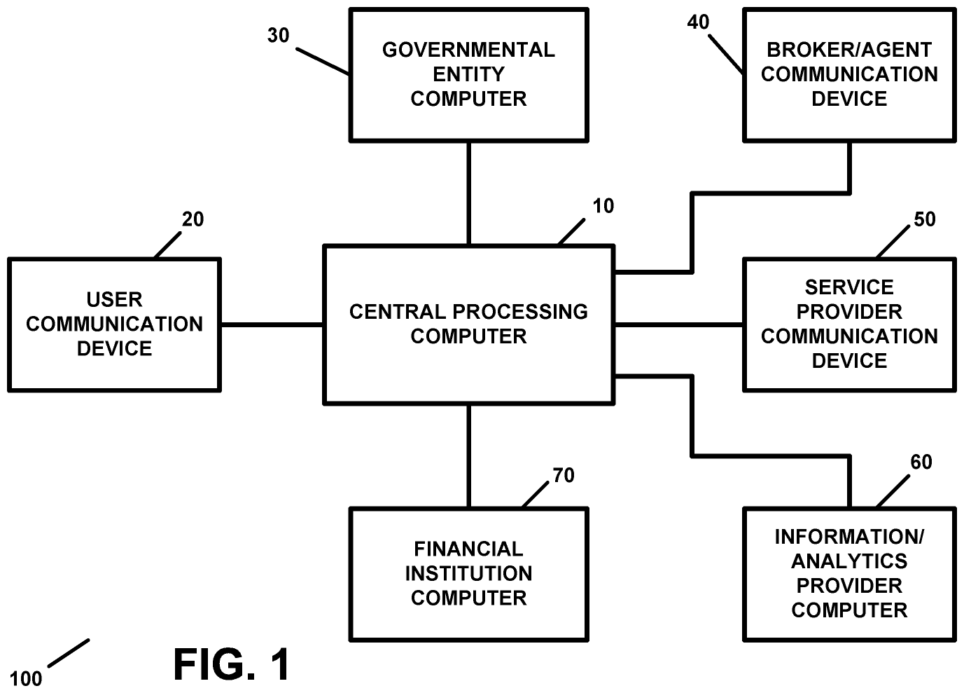

FIG. 1 illustrates a preferred embodiment of the apparatus of the present invention which is designated by reference numeral 100, in block diagram form. With reference to FIG. 1, the apparatus includes a central processing computer or server computer 10 (hereinafter “central processing computer 10”). The central processing computer 10 can include any number of central processing computers and/or computer systems. In this regard, the central processing computer 10 can be a single computer or server computer or can include a plurality of any number of computers, server computers, or computer systems. In this regard, in any and/or all of the embodiments described herein, the central processing computer 10 can be comprised of one computer or computer system and/or can be comprised of a plurality of computers or computer systems. Any number of central processing computers 10 can be utilized in the apparatus 100 of the present invention.

In the preferred embodiment, the central processing computer 10 is specially programmed and specially configured to provide a marketing platform for real estate assets and/or high value assets of any type or kind. In the preferred embodiment, the central processing computer 10 is specially programmed and specially configured to provide and/or to perform all of the functionalities described herein as being performed by the apparatus 100 and methods of the present invention. The central processing computer 10, in the preferred embodiment, is also specially programmed and/or specially configured to perform any of and/or all of the processing routines described herein as being performed by the apparatus 100 of the present invention.

In the preferred embodiment, the central processing computer 10 will have a website or websites associated therewith which can serve as an interface for any of the users, or for any other entities, described herein as using or participating in using the apparatus 100 and methods of the present invention.

With reference to FIG. 1, the apparatus 100 also includes any number of user computers or user communication devices 20 (hereinafter “user communication device 20”). The user communication device 20 can be utilized by any user, individual, party, or entity, who or which uses the apparatus 100 of the present invention in order to communicate with the central processing computer(s) 10 described herein and/or to communicate with any of the other computers and/or communication devices described herein as being utilized in or with the apparatus 100.

In the preferred embodiment, the user communication device 20 can communicate with, and/or can be linked with, the central processing computer(s) 10 and/or any other computers or communication devices described herein, via a wired communication network, a wireless communication network, or via any combination of wired and/or wireless communication networks.

The user communication device 20 can be utilized by any of the herein-described users in order to interface with, and/or interact with, the central processing computer 10 or with any of the other computers and communication devices described herein as being used in or with the apparatus 100. In the preferred embodiment, the user communication device 20 can be a computer, a computer terminal, a terminal device connected to, or associated with, the central processing computer 10, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The user communication device 20 can also be a server computer, a network computer, or any other computer capable of being utilized in a network.

The user communication device 20 can also include and/or be utilized in conjunction with a network computer or any other computer which can be utilized to send and receive text messages and/or e-mail messages for or on behalf of a user. The network computer, in the preferred embodiment, can be any computer which can be used in a computer communication network to transmit and/or receive text messages or e-mail messages to and/or from any of the herein-described user communication devices 20 and/or can provide a text message or an e-mail message to the user communication device 20. In any and/or all of the embodiments described herein, the respective network computer or other computer can also automatically transmit or “push” a text message or an e-mail message or e-mail messages to a user communication device 20 as soon as same are received and/or in real-time.

In any and/or all of the embodiments described herein, the respective network computer or computer can also serve as a conventional text message server or as an e-mail server which can allow a user to request or “pull” a text message or an e-mail message or e-mail messages to a user communication device 20 when requested by the user or other authorized individual. In this regard, any network computer or other computer, such as one that can receive and send text messages or email messages to a user communication device 20 is also considered to be a user communication device 20 in and of itself. In this regard, a text message server or an e-mail server can also be deemed to be a user communication device 20. In a preferred embodiment, each user communication device 20 can also have a website or websites associated therewith.

In the preferred embodiment, any number of user communication devices 20 can be utilized in, or in connection with, the apparatus 100. The user communication devices 20 described herein can be utilized to communicate with the central processing computer(s) 10 and/or with any other computers or communication devices described herein in a bi-directional manner.

With reference once again to FIG. 1, the apparatus also includes a governmental entity computer or computer system 30 (hereinafter “governmental entity computer 30”) which can be used by, and/or which can be associated with, a governmental entity which can, for example, be a national government, federal government, regional government, state government, provincial government, local government, municipal government, or any other government of any political subdivision or geographical subdivision. In a preferred embodiment, the governmental entity computer 30 can be utilized by any governmental entity which maintains records and/or information regarding real estate assets and/or any other high value assets in, within, or under, its jurisdiction. In a preferred embodiment, the governmental entity computer 30 can be utilized by any governmental entity which maintains tax records and/or related information regarding real estate assets and/or any other high value assets in, within, or under, its jurisdiction.

The governmental entity computer 30 can also be utilized to allow the governmental entity, or an employee or agent of same, to communicate with and/or interact with the central processing computer(s) 10, the user communication devices 20, and/or with any of the other computers and communication devices described herein as being utilized in or with the apparatus 100. In the preferred embodiment, the governmental entity computer 30 can communicate with, and/or can be linked with, the central processing computer(s) 10 and/or any other computer or communication devices described herein, via a wired communication network, a wireless communication network, or via any combination of wired and/or wireless communication networks.

The governmental entity computer 30 can be used by its respective governmental entity for any purpose. The governmental entity computer 40 can be utilized by any of the herein-described governmental entities in order to interface with, and/or interact with, the central processing computer 10 or with any other computers and communication devices described herein as being used in or with the apparatus 100. In a preferred embodiment, each governmental entity computer 30 can include any number of computers, server computers, or computer systems. In a preferred embodiment, each governmental entity computer 30 can also have a website or websites associated therewith.

With reference once again to FIG. 1, the apparatus also includes a broker/agent computer or communication device 40 (hereinafter “broker/agent communication device 40”) which can be used by, and/or which can be associated with, a real estate broker and/or agent and/or any broker or agent who or which engages in facilitating transaction involving any high value asset or high valued assets. The broker/agent communication device 40 can be utilized to allow the respective broker or agent, or an employee or agent of same, to communicate with and/or interact with the central processing computer(s) 10, the user communication devices 20, the governmental entity computers 30, and/or with any of the other computers and communication devices described herein as being utilized in or with the apparatus 100. In the preferred embodiment, the broker/agent communication device 40 can communicate with, and/or can be linked with, the central processing computer(s) 10 and/or any other computer or communication devices described herein, via a wired communication network, a wireless communication network, or via any combination of wired and/or wireless communication networks.

The broker/agent communication device 40 can be used by its respective broker, agent, or employee or agent of same, for any purpose. The broker/agent communication device 40 can be utilized by any of the herein-described brokers or agents, or employees or agents of same, in order to interface with, and/or interact with, the central processing computer 10 or with any other computers and communication devices described herein as being used in or with the apparatus 100. In a preferred embodiment, each broker/agent communication device 40 can also have a website or websites associated therewith.

In the preferred embodiment, the broker/agent communication device 40 can be a computer, a computer terminal, a terminal device connected to, or associated with, the central processing computer 10, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The broker/agent communication device 40 can also be a server computer, a network computer, or any other computer capable of being utilized in a network.

With reference once again to FIG. 1, the apparatus also includes a service provider computer or communication device 50 (hereinafter “service provider communication device 50”) which can be used by, and/or which can be associated with, any person or entity who or which can provide a service to or for any of the owners and/or prospective purchasers of any of the herein-described real estate assets and/or high value assets. In a preferred embodiment, a service provider can be any provider of any good or service which can be the subject of any type or kind of commerce. For example, service providers can be any individuals and/or entities who or which can provide any type or kind of good or service for any owners and/or prospective purchasers of any of the herein-described real estate assets and/or high value assets. In this regard, service providers can, for example, include, any type or kind of attorneys, agents, brokers, marketing professional, finance professionals, construction professionals, architectural professions, appraisers, engineers, inspector, pest control professional, insurance professionals, title insurance professionals, repair professional, rehabilitation professionals, interior and/or exterior decorating professions, and/or any other providers of any goods and/or services which may be of interest to any of the herein-described owners and/or prospective purchasers of any of the herein-described real estate assets and/or high value assets.

The service provider communication device 50 can be utilized to allow the service provider, or an employee or agent of same, to communicate with and/or interact with the central processing computer(s) 10, the user communication devices 20, the governmental entity computers 30, the broker/agent communication devices 40, and/or with any of the other computers and communication devices described herein as being utilized in or with the apparatus 100. In the preferred embodiment, the service provider communication device 50 can communicate with, and/or can be linked with, the central processing computer(s) 10 and/or any other computer or communication devices described herein, via a wired communication network, a wireless communication network, or via any combination of wired and/or wireless communication networks.

The service provider communication device 50 can be used by its respective service provider, or employee or agent of same, for any purpose. The service provider communication device 50 can be utilized by any of the herein-described service providers, or employees or agents of same, in order to interface with, and/or interact with, the central processing computer 10 or with any other computers and communication devices described herein as being used in or with the apparatus 100. In a preferred embodiment, each service provider communication device 50 can also have a website or websites associated therewith.

In the preferred embodiment, the service provider communication device 50 can be a computer, a computer terminal, a terminal device connected to, or associated with, the central processing computer 10, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The service provider communication device 50 can also be a server computer, a network computer, or any other computer capable of being utilized in a network.

With reference once again to FIG. 1, the apparatus also includes an information/analytics provider computer or communication device 60 (hereinafter “information/analytics provider computer 60”) which can be used by, and/or which can be associated with, any person or entity who or which can provide analytics information, valuation information, and/or any news and/or other information, which may be deemed useful or desirable by or to any of the owners and/or prospective purchasers of any of the herein-described real estate assets and/or high value assets.

The information/analytics provider computer 60 can be utilized to allow the provider of the respective information and/or analytics data and/or information, or an employee or agent of same, to communicate with and/or interact with the central processing computer(s) 10, the user communication devices 20, the governmental entity computers 30, the broker/agent communication devices 40, the service provider communication devices 50, and/or with any of the other computers and communication devices described herein as being utilized in or with the apparatus 100. In the preferred embodiment, the information/analytics provider computer 60 can communicate with, and/or can be linked with, the central processing computer(s) 10 and/or any other computer or communication devices described herein, via a wired communication network, a wireless communication network, or via any combination of wired and/or wireless communication networks.

The information/analytics provider computer 60 can be used by its respective information and/or analytics provider, or employee or agent of same, for any purpose. The information/analytics provider computer 60 can be utilized by any of the herein-described information and/or analytics provider, or employee or agent of same, in order to interface with, and/or interact with, the central processing computer 10 or with any other computers and communication devices described herein as being used in or with the apparatus 100. In a preferred embodiment, each information/analytics provider computer 60 can also have a website or websites associated therewith.

In the preferred embodiment, the information/analytics provider computer 60 can be a computer, a computer terminal, a terminal device connected to, or associated with, the central processing computer 10, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The information and/or analytics provider, or employee or agent of same, can also be a server computer, a network computer, or any other computer capable of being utilized in a network.

With reference once again to FIG. 1, the apparatus also includes a financial institution computer or communication device 70 (hereinafter “financial institution computer 70”) which can be used by, and/or which can be associated with, any financial institution, financial intermediary, or any provider of financial products and/or services.

The financial institution computer 70 can be utilized to allow the financial institution, financial intermediary, or any provider of financial products and/or services, or an employee or agent of same, to communicate with and/or interact with the central processing computer(s) 10, the user communication devices 20, the governmental entity computers 30, the broker/agent communication devices 40, the service provider communication devices 50, the information/analytics provider computer 60, and/or with any of the other computers and communication devices described herein as being utilized in or with the apparatus 100. In the preferred embodiment, the financial institution computer 70 can communicate with, and/or can be linked with, the central processing computer(s) 10 and/or any other computer or communication devices described herein, via a wired communication network, a wireless communication network, or via any combination of wired and/or wireless communication networks.

The financial institution computer 70 can be used by its respective financial institution, financial intermediary, or any provider of financial products and/or services, or employee or agent of same, for any purpose. The financial institution computer 70 can be utilized by any of the herein-described financial institutions, financial intermediaries, or any providers of financial products and/or services, in order to interface with, and/or interact with, the central processing computer 10 or with any other computers and communication devices described herein as being used in or with the apparatus 100. In a preferred embodiment, each financial institution computer 70 can also have a website or websites associated therewith.

In the preferred embodiment, the financial institution computer 70 can be a computer, a computer terminal, a terminal device connected to, or associated with, the central processing computer 10, a kiosk, a personal computer, a home computer, a personal communication device, a telephone, an interactive television, a smart phone, a cellular telephone, a wireless telephone, a videophone, a video telephone, a personal digital assistant, a watch, a smart watch, a 360 degree video headset or interface, a VR (virtual reality) headset or interface, an AR (augmented reality) headset or interface, a wearable communication device, glasses equipped with communications equipment, a beeper or a pager, or any other communication device or equipment. The financial institution computer 70 can also be a server computer, a network computer, or any other computer capable of being utilized in a network.

In a preferred embodiment, any number of central processing computers 10, user communication devices 20, governmental entity computers 30, broker/agent communication devices 40, service provider communication devices 50, information/analytics provider computers 60, and financial institution computers 70, can be utilized in, and/or in connection with or in association with, the apparatus 100 of the present invention.

In a preferred embodiment, any of the central processing computers 10, the user communication devices 20, the governmental entity computers 30, the broker/agent communication devices 40, the service provider communication devices 50, the information/analytics provider computers 60, and/or the financial institution computers 70, can communicate with any other central processing computer(s) 10, user communication device(s) 20, governmental entity computer(s) 30, the broker/agent communication device(s) 40, the service provider communication device(s) 50, the information/analytics provider computer(s) 60, and/or the financial institution computer(s) 70, in a bi-directional manner. In this regard, any computer or communication device described herein can communicate, in a bi-directional manner, with any other computer or communication device regardless of whether the respective computer or communication device is a central processing computer 10, a user communication device 20, a governmental entity computer 30, a broker/agent communication device 40, a service provider communication device 50, an information/analytics provider computer 60, and/or a financial institution computer 70.

In the preferred embodiment, the apparatus 100 and methods of the present invention is utilized on, over, or via, the Internet and/or the World Wide Web. In the preferred embodiment, the apparatus 100 and methods of the present invention can also be utilized over any suitable communication network and/or any combination of computer networks, including, but not limited to the Internet, the World Wide Web, a telecommunication network or system, a telephone network or system, a cable television communication network or system, a satellite television communication network or system, a digital television network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video and communication network or system, a streaming audio communication network or system, a live video communication network or system, and/or any other suitable communications network or system, and/or any combination(s) thereof.

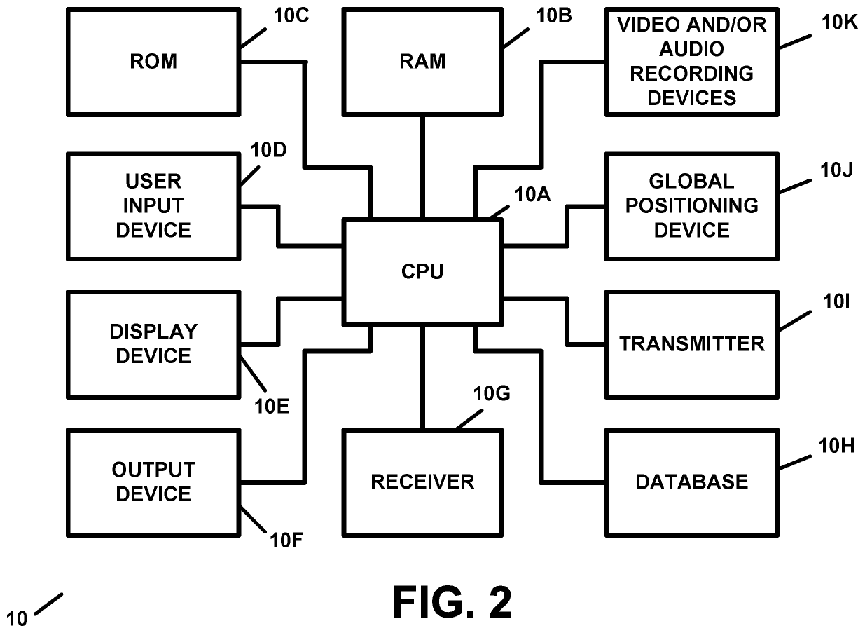

FIG. 2 illustrates the central processing computer 10 of FIG. 1, in block diagram form. With reference to FIG. 2, the central processing computer 10 includes a central processing unit (CPU) 10A. The central processing unit (CPU) 10A may be a microprocessor, a microcomputer, a minicomputer, a macro-computer, or a mainframe computer, depending upon the application. The CPU 10A is specially programmed and/or specially configured to perform all of the functionality described herein as being performed by the central processing computer 10.

The central processing computer 10 also includes a random access memory (RAM) device(s) 10B and a read only memory (ROM) device(s) 10C which are connected to the CPU 10A. The central processing computer 10 also includes a user input device(s) 10D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the central processing computer 10. The input device(s) 10D is also connected to the CPU 10A. In a preferred embodiment, data, information, instructions, or commands, can also be input using a microphone as an input device and recognition software.

The central processing computer 10 also includes a display device 10E, such as a display monitor and/or a display screen, for providing the herein-described data and/or information to the operator or user of the central processing computer 10. The display device 10E is also connected to the CPU 10A.

The central processing computer 10 can also include an output device 10F, such as a printer, a display device, and/or a modem, for outputting, in either or both of hard copy form or electronic form, any of the data and/or information which is described herein as being provided by, from, or at, the central processing computer 10. The output device 10F can also be connected to the CPU 10A.

The central processing computer 10 can also include a receiver 10G for receiving data and/or information, including any of the herein-described data and/or information, and/or any of the other data and/or information described herein as being provided to the central processing computer 10, from any of the user communication devices 20, from any of the governmental entity computers 30, from any of the broker/agent communication devices 40, from any of the service provider communication devices 50, from any of the information/analytics provider computers 60, and/or from any of the financial institution computers 70, or from any of the other central processing computers 10.

The central processing computer 10 can also include a database(s) 10H, which can contain any data and/or information, and/or software programs or software applications, which may be needed, required, and/or which may be desired, for performing any and/or all of the functionality and/or processing routines described herein as being performed by the central processing computer 10 and/or the by the apparatus 100.

In a preferred embodiment, the database 10H can, for example, contain any data and/or information regarding each user, individual, party, or entity, who or which uses the apparatus 100 of the present invention, including, but not limited to, the respective user's, individual's, party's, or entity's, name, address, telephone number, cellular telephone number, text message number, SMS message number, e-mail address, and/or any other data and/or information needed, required, or desired, for performing any and/or all of the functions and/or functionalities described herein as being performed by the apparatus 100 of the present invention.

The database 10H can also contain information regarding any and/or all real estate assets which are the subject of any public record or public records, and/or which are otherwise registered with the apparatus 100. In a preferred embodiment, the database 10H can contain and/or include, for each real estate asset, which is either the subject of any public record or public records, and/or which are otherwise registered with the apparatus 100, the address of the real estate asset, the name, if applicable, of the real estate asset, the registered owner or owners of the real estate asset, current taxes for the real estate asset, a past purchase price or past purchase prices for the real estate asset, past taxes due, owed, or paid, for the real estate asset, past owners of the real estate asset, past dates of sale or transfer for the real estate asset, type of deed involved in any transfer regarding the real estate asset, information regarding the chain of title of the real estate asset, and/or any specific details regarding and/or specific to the real estate asset, such as, for example, but not limited to, number of bedrooms, number of bathrooms, square footage, size of parcel of land on which the real estate assets is situated, number and size of apartments in the real estate asset, level of occupancy of the real estate asset, rent roll of the real estate asset, number and size of commercial or rental units in a commercial real estate asset, level of occupancy of the commercial real estate asset, rent roll of the commercial real estate asset, acreage of a vacant land asset, permits, building permits, certificates of occupancy, and/or any other description or descriptions of and/or for the real estate asset.

The database 10H can also contain and/or include, for each real estate asset, information regarding a description of the real estate asset, information regarding whether the real estate asset is currently listed for sale or not currently listed for sale, information regarding any names and/or a listing of, and/or any offers or proposed offers made by, any users who are interested in purchasing the real estate asset, and/or in purchasing the real estate asset if it would be offered for sale. The database 10H can also contain and/or include, for each real estate asset, any information regarding any pending offer(s) to sell and/or any offer(s) to buy any real estate asset. The database 10H can also contain and/or include, for each real estate asset, any other information which may be needed, required, or desired, regarding that real estate asset for performing any and/or all of the functions or functionalities of the apparatus 100.

The database 10H can also contain information regarding any other high value assets which are either the subject of any public record or public records, and/or which are otherwise registered with the apparatus 100. In a preferred embodiment, the database 10H can contain and/or include, for each high value asset, which is either the subject of any public record or public records, and/or which are otherwise registered with the apparatus 100, a name and/or description of the high-value asset, the name and address of the owner, the purchase price or past purchase prices, a value, and/or an appraised value, of or for the high-value asset, and/or any other information which may be needed, required, or desired, regarding the high value asset for performing any and/or all of the functions or functionalities of the apparatus 100.

The database 10H can also contain and/or include any virtual tour information and/or a video tour video file or a video presentation for any real estate asset and/or a video presentation of any high-value asset. In a preferred embodiment, any video presentation can be provided in any suitable format and can also be provided in a virtual reality (VR) format and/or in an augmented reality (AR) format.

The database 10H can also contain any needed software for providing electronic forums, chat rooms, video conference calls, any video conference calls, any video chat room calls, and/or any telephone conference calls, which can be monitored and recorded, and the database 10H can store recorded electronic forum sessions, chat room sessions, video conference calls, video chat room calls, and/or telephone conference calls, involving any user, individuals, parties, or entities, or users, and/or any individuals representing any of the foregoing, who or which utilize the apparatus 100 of the present invention in order to interact with any owner of any real estate asset or any owner of any high-value asset, or any agent or employee of same.

The database 10H can also contain software programs or software applications needed for providing 360 degree videos, immersive videos, and/or spherical videos, VR presentations, and/or AR presentations, for any of the real estate assets or high-value assets described herein.

The database 10H can also store any data and/or information, and/or any software programs or software applications, needed or required for allowing the central processing computer 10 to perform any and/or all of the functions and/or functionalities described herein as capable of being performed by the central processing computer 10 and/or the apparatus 100 of the present invention.

The database 10H can also contain any data and/or information stored in the respective databases of any of the herein-described user communication devices 20, governmental entity computers 30, broker/agent communication devices 40, service provider communication devices 50, information/analytics provider computers 60, and/or financial institution computers 70, which are utilized in conjunction with the apparatus 100 and methods of the present invention.

The database 10H can also contain any other data and/or information, and/or software programs or software applications, which may be needed and/or desired for performing any and/or all of the processing routines and/or functionality described herein as being provided by the central processing computer 10 and/or apparatus 100. In this regard, whether or not noted herein, the database 10H can contain any and/or all data and/or information, which may be needed or desired in performing any and/or all of the functionality described herein as being performed by the apparatus 100, by the central processing computer 10, and/or by any of the herein-described user communication devices 20, governmental entity computers 30, broker/agent communication devices 40, service provider communication devices 50, information/analytics provider computers 60, and/or financial institution computers 70. The database 10H can also be connected to the CPU 10A.

The central processing computer 10 can also include a transmitter 10I for transmitting data and/or information, including any of the herein-described data and/or information, and/or any other data and/or information described herein as being provided by, from, or to, the central processing computer 10, any of the user communication devices 20, any of the governmental entity computers 30, any of the broker/agent communication devices 40, any of the service provider communication devices 50, any of the information/analytics provider computers 60, and/or any of the financial institution computers 70, or to any of the other central processing computer 10. The transmitter 10I can also be connected to the CPU 10A.

With reference to FIG. 2, the central processing computer 10 can also include a global positioning device 10J for determining the position or location of the central processing computer 10. In a preferred embodiment, the global positioning device 10J can be utilized in order to determine the position or location of the central processing computer 10 so as to, for example, determine a jurisdiction in which the central processing computer 10 is located at any given time.

With reference to FIG. 2, the central processing computer 10 can also include a video and/or audio recording device(s) 10K which can include a camera and/or a video recording device for recording pictures or video and/or video clips and/or a microphone or an audio recording device for recording audio or audio clips which can be recorded by, and/or transmitted live, by or from the central processing computer 10, or which can be recorded by, and stored at or in, the central processing computer 10 for transmission by or from the central processing computer 10 at a later time. The video and/or audio recording device(s) 10K can also be utilized to facilitate one-way broadcasts from the central processing computer 10, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the central processing computer 10 can engage in telephone calls and video conferencing calls via the same. The user or operator of the central processing computer 10 can also use the video and/or audio recording device(s) 10K to record and broadcast or transmit content via its transmitter 10I.

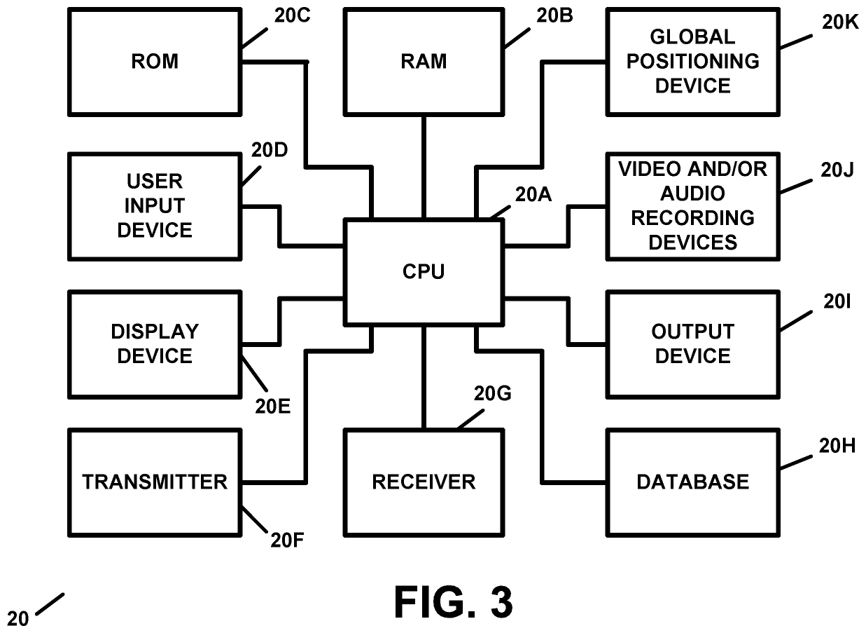

FIG. 3 illustrates the user communication device 20 of FIG. 1, in block diagram form. The user communication device 20, in the preferred embodiment, can be a computer, a personal computer, a home computer, a personal communication device, a telephone, an interactive television, a smart phone, a cellular telephone, a wireless telephone, a videophone, a video telephone, a personal digital assistant, a watch, a VR (virtual reality) headset or interface, an AR (augmented reality) headset or interface, a wearable communication device, glasses equipped with communications equipment, or any other communication device or equipment. The user communication device 20 can also be a computer terminal, a terminal device connected to, or associated with, the central processing computer 10, or a kiosk. The user communication device 20 can also be any headset or other wearable device which can have all of the herein-described components of the user communication device 20. In instances when a headset is used as, or in conjunction with, the user communication device 20, the user of the same can verbally input information and/or instructions into the user communication device 20 via the microphone of the video and/or audio recording device(s) 20J described herein. In such an embodiment, the user communication device 20, and/or the headset utilized in conjunction with the same, can be specially programmed and/or equipped with voice recognition software in order to process the user's verbal or voice comments, commands, and/or instructions. The user communication device 20 can also be integrated within a headset or other wearable device. The headset or other wearable device can also be a component of the user communication device 20. The user communication device 20 can also be a server computer, a network computer, or any other computer capable of being utilized in a network.

With reference to FIG. 3, in the preferred embodiment, the user communication device 20 includes a central processing unit or CPU 20A which, in the preferred embodiment, is a microprocessor. The CPU 20A may also be a microcomputer, a minicomputer, a macro-computer, and/or a mainframe computer, depending upon the application. The CPU 20A is specially programmed and/or specially configured to perform any and/or all of the functionality described herein as being performed by the user communication device 20.

The user communication device 20 also includes a random access memory (RAM) device(s) 20B and a read only (ROM) memory device(s) 20C, each of which is connected to the CPU 20A, and a user input device 20D, for entering data or information and/or instructions and/or commands into the user communication device 20. The user input device 20D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the user communication device 20. The input device(s) 20D is/are also connected to the CPU 20A.

The user communication device 20 also includes a display device 20E for displaying data and/or information to a user. The user communication device 20 also includes a transmitter(s) 20F, for transmitting signals and/or data and/or information to any one or more of the central processing computers 10, the governmental entity computers 30, the broker/agent communication devices 40, the service provider communication devices 50, the information/analytics provider computers 60, and/or the financial institution computers 70, and/or any other user communication devices 20, which may be utilized in conjunction with the apparatus 100 of the present invention. The user communication device 20 also includes a receiver 20G, for receiving signals and/or data and/or information from any one or more of the central processing computers 10, the governmental entity computers 30, the broker/agent communication devices 40, the service provider communication devices 50, the information/analytics provider computers 60, and/or the financial institution computers 70, and/or any other user communication devices 20, which may be utilized in conjunction with the apparatus 100 of the present invention.

The user communication device 20 also includes a database(s) 20H. The database 20H can contain and/or be linked to any of the data and/or information described herein as being stored in the database 10H.

The database 20H can also contain and/or include any data and/or information regarding the user, individual, party, or entity (hereinafter referred to as a “user”) who or which utilizes the user communication device 20, and for each user, the database 20H can contain and/or include, but not be limited to, data and/or information regarding the user's, or each user's name, address, telephone number (s), cellular telephone number(s), mobile or wireless telephone number(s), e-mail address or e-mail addresses, and/or text message, instant message, SMS message, or MMS message, or any other messaging, telephone number or other address or identifier. The database 20H can also contain any data and/or information regarding any real estate asset(s) and/or any high value asset(s) in which the user has indicated having an interest in and/or any offer or proposed offer the user has made for the respective real estate or for the respective high value asset.

The database 20H can also contain any data and/or information which may be required, and/or which may be desired, for performing any of the functionality and/or processing routines described herein as being performed by the user communication device 20 and/or the apparatus 100. In a preferred embodiment, the database 20H can also include any of the data and/or information described herein as being contained in the respective databases of the central processing computer(s) 10, the governmental entity computers 30, the broker/agent communication devices 40, the service provider communication devices 50, the information/analytics provider computers 60, and/or the financial institution computers 70, and/or any other user communication devices 20. The database 20H can also be connected to the CPU 20A.

The user communication device 20 also includes an output device 201 for outputting any of the data, information, and/or reports, described herein as being generated by or via the user communication device 20. In the preferred embodiment, the output device 201 can be a printer, a display, a transmitter, a modem, and/or any other device which can be used to output data or information of any kind or type.

The user communication device 20 also includes a video and/or audio recording device(s) 20J which can include a camera and/or a video recording device for recording pictures or video and/or video clips and/or a microphone or an audio recording device for recording audio or audio clips which can be recorded by, and/or transmitted live, by or from the user communication device 20, or which can be recorded by, and stored at or in, the user communication device 20 for transmission by or from the user communication device 20 at a later time. The video and/or audio recording device(s) 20J can also be utilized to facilitate one-way broadcasts from the user communication device 20, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the user communication device 20 can engage in telephone calls and video conferencing calls via the same. The user of the user communication device 20 can also use the video and/or audio recording device(s) 20J to record and broadcast or transmit content via its transmitter 20F.

With reference to FIG. 3, the user communication device 20, in the preferred embodiment, also includes a global positioning device 20K for determining the position or location of the user communication device 20. In a preferred embodiment, the global positioning device 20K can be utilized to determine the position or location of the user communication device 20 so as to, for example, determine a municipality, political subdivision, or jurisdiction, in which the user communication device 20 is located at any time.

For example, if the user and his or her user communication device 20 are positioned or located at a fixed location, or are moving, the global positioning device 20K can determine the position or location of the user's user communication device 20 at the time or instant the user is using the user communication device 20. The global positioning device 20K can also be utilized to determine where the user communication device 20 is located at any given time. The global positioning device 20K can also be connected with the CPU 20A.

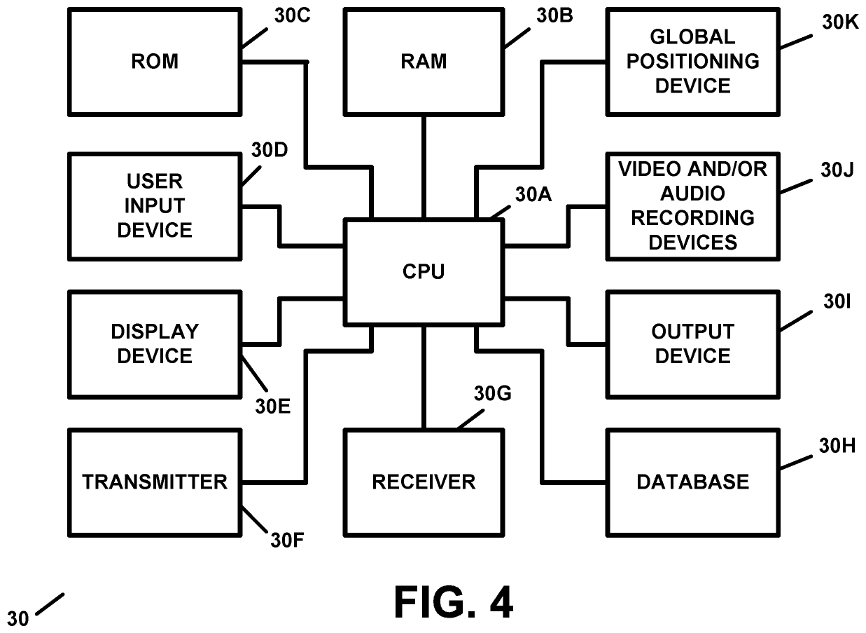

FIG. 4 illustrates the governmental entity computer 30 of FIG. 1, in block diagram form. The governmental entity computer 30, in the preferred embodiment, can be a computer, a server computer, a computer terminal or a terminal device connected to a computer or a server computer, a personal computer, a home computer, a personal communication device, a telephone, an interactive television, a smart phone, a cellular telephone, a wireless telephone, a videophone, a video telephone, a personal digital assistant, a watch, a smart watch, a VR (virtual reality) headset or interface, an AR (augmented reality) headset or interface, a wearable communication device, glasses equipped with communications equipment, a beeper or a pager, or any other communication device or equipment. The governmental entity computer 30 can also be any computer capable of being utilized in a network.

With reference to FIG. 4, in the preferred embodiment, the governmental entity computer 30 includes a central processing unit or CPU 30A which, in the preferred embodiment, is a microprocessor. The CPU 30A may also be a microcomputer, a minicomputer, a macro-computer, and/or a mainframe computer, depending upon the application. The CPU 30A is specially programmed and/or specially configured to perform any and/or all of the functionality described herein as being performed by the governmental entity computer 30.

The governmental entity computer 30 also includes a random access memory (RAM) device(s) 30B and a read only (ROM) memory device(s) 30C, each of which is connected to the CPU 30A, and a user input device 30D, for entering data or information and/or instructions and/or commands into the governmental entity computer 30. The user input device 30D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the governmental entity computer 30. The input device(s) 30D is/are also connected to the CPU 30A.

The governmental entity computer 30 also includes a display device 30E for displaying data and/or information to a user. The governmental entity computer 30 also includes a transmitter(s) 30F, for transmitting signals and/or data and/or information to any one or more of the central processing computers 10, the user communication devices 20, the broker/agent communication devices 40, the service provider communication devices 50, the information/analytics provider computers 60, and/or the financial institution computers 70, and/or any other governmental entity computers 30, which may be utilized in conjunction with the apparatus 100 of the present invention. The governmental entity computer 30 also includes a receiver 30G, for receiving signals and/or data and/or information from any one or more of the central processing computers 10, the user communication devices 20, the broker/agent communication devices 40, the service provider communication devices 50, the information/analytics provider computers 60, and/or the financial institution computers 70, and/or any other governmental entity computers 30, which may be utilized in conjunction with the apparatus 100 of the present invention.

The governmental entity computer 30 also includes a database(s) 30H. The database 30H can contain and/or be linked to any of the data and/or information described herein as being stored in the database 10H.

The database 30H can also contain and/or include any data and/or information regarding any and/or all real estate assets of public record, or otherwise registered with the governmental entity, which are within or under the jurisdiction of the respective governmental entity which is using the governmental entity computer 30 and/or any other high valued assets which are registered with the respective governmental entity which is using the governmental entity computer 30.

In a preferred embodiment, the database 30H can contain and/or include, for each real estate asset, which is either the subject of any public record or public records, and/or which are otherwise registered with the apparatus 100, the address of the real estate asset, the name, if applicable, of the real estate asset, the registered owner or owners of the real estate asset, current taxes for the real estate asset, a past purchase price or past purchase prices for the real estate asset, past taxes due, owed, or paid, for the real estate asset, past owners of the real estate asset, past dates of sale or transfer for the real estate asset, type of deed involved in any transfer regarding the real estate asset, information regarding the chain of title of the real estate asset, and/or any specific details regarding and/or specific to the real estate asset, such as, for example, but not limited to, number of bedrooms, number of bathrooms, square footage, size of parcel of land on which the real estate assets is situated, number and size of apartments in the real estate asset, level of occupancy of the real estate asset, rent roll of the real estate asset, number and size of commercial or rental units in a commercial real estate asset, level of occupancy of the commercial real estate asset, rent roll of the commercial real estate asset, acreage of a vacant land asset, permits, building permits, certificates of occupancy, and/or any other description or descriptions of and/or for the real estate asset.

The database 30H can also contain information regarding any other high value assets which are either the subject of any public record or public records, and/or which are otherwise registered with the governmental entity. In a preferred embodiment, the database 30H can contain and/or include, for each high value asset, which is either the subject of any public record or public records, and/or which are otherwise registered with the governmental entity, a name and/or description of the high-value asset, the name and address of the owner, the purchase price or past purchase prices, a value, and/or an appraised value, of or for the high-value asset, and/or any other information which may be needed, required, or desired, regarding the high value asset for performing any and/or all of the functions or functionalities of the apparatus 100.

The database 30H can also contain any data and/or information which may be required, and/or which may be desired, for performing any of the functionality and/or processing routines described herein as being performed by the governmental entity computer 30. In a preferred embodiment, the database 30H can also include any of the data and/or information described herein as being contained in the respective databases of the central processing computer(s) 10, the user communication devices 20, the broker/agent communication devices 40, the service provider communication devices 50, the information/analytics provider computers 60, and/or the financial institution computers 70, and/or any other governmental entity computers 30. The database 30H can also be connected to the CPU 30A.

The governmental entity computer 30 also includes an output device 301 for outputting any of the data, information, and/or reports, described herein as being generated by or via the governmental entity computer 30. In the preferred embodiment, the output device 301 can be a printer, a display, a transmitter, a modem, and/or any other device which can be used to output data or information of any kind or type.

The governmental entity computer 30 also includes a video and/or audio recording device(s) 30J which can include a camera and/or a video recording device for recording pictures or video and/or video clips and/or a microphone or an audio recording device for recording audio or audio clips which can be recorded by, and/or transmitted live, by or from the governmental entity computer 30, or which can be recorded by, and stored at or in, the governmental entity computer 30 for transmission by or from the governmental entity computer 30 at a later time. The video and/or audio recording device(s) 30J can also be utilized to facilitate one-way broadcasts from the governmental entity computer 30, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the governmental entity computer 30 can engage in telephone calls and video conferencing calls via the same. The user of the governmental entity computer 30 can also use the video and/or audio recording device(s) 30J to record and broadcast or transmit content via its transmitter 30F.

With reference to FIG. 4, the governmental entity computer 30, in the preferred embodiment, also includes a global positioning device 30K for determining the position or location of the governmental entity computer 30. In a preferred embodiment, the global positioning device 30K can be utilized to determine the position or location of the governmental entity computer 30 so as to, for example, determine a municipality, political subdivision, or jurisdiction, in which the governmental entity computer 30 is located at any time.

For example, if the governmental entity computer 30 is at a fixed location, or is moving, the global positioning device 30K can determine the position or location of the governmental entity computer 30 at the time or instant the same is being utilized. The global positioning device 30K can also be utilized to determine where the governmental entity computer 30 is located at any given time. The global positioning device 30K can also be connected with the CPU 30A.

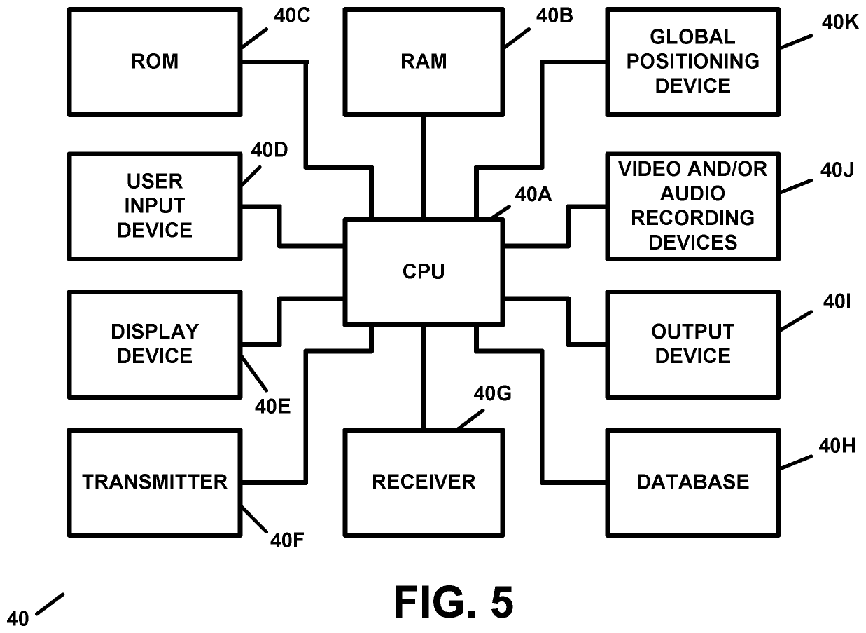

FIG. 5 illustrates the broker/agent communication device 40 of FIG. 1, in block diagram form. The broker/agent communication device 40, in the preferred embodiment, can be a computer, a server computer, a computer terminal or a terminal device connected to a computer or a server computer, a personal computer, a home computer, a personal communication device, a telephone, an interactive television, a smart phone, a cellular telephone, a wireless telephone, a videophone, a video telephone, a personal digital assistant, a watch, a smart watch, a VR (virtual reality) headset or interface, an AR (augmented reality) headset or interface, a wearable communication device, glasses equipped with communications equipment, a beeper or a pager, or any other communication device or equipment. The broker/agent communication device 40 can also be any computer capable of being utilized in a network.

With reference to FIG. 5, in the preferred embodiment, the broker/agent communication device 40 includes a central processing unit or CPU 40A which, in the preferred embodiment, is a microprocessor. The CPU 40A may also be a microcomputer, a minicomputer, a macro-computer, and/or a mainframe computer, depending upon the application. The CPU 40A is specially programmed and/or specially configured to perform any and/or all of the functionality described herein as being performed by the broker/agent communication device 40.

The broker/agent communication device 40 also includes a random access memory (RAM) device(s) 40B and a read only (ROM) memory device(s) 40C, each of which is connected to the CPU 40A, and a user input device 40D, for entering data or information and/or instructions and/or commands into the broker/agent communication device 40. The user input device 40D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the broker/agent communication device 40. The input device(s) 40D is/are also connected to the CPU 40A.

The broker/agent communication device 40 also includes a display device 40E for displaying data and/or information to a user. The broker/agent communication device 40 also includes a transmitter(s) 40F, for transmitting signals and/or data and/or information to any one or more of the central processing computers 10, the user communication devices 20, the governmental entity computers 30, the service provider communication devices 50, the information/analytics provider computers 60, the financial institution computers 70, and/or any other broker/agent communication devices 40, which may be utilized in conjunction with the apparatus 100 of the present invention. The broker/agent communication device 40 also includes a receiver 40G, for receiving signals and/or data and/or information from any one or more of the central processing computers 10, the user communication devices 20, the governmental entity computers 30, the service provider communication devices 50, the information/analytics provider computers 60, the financial institution computers 70, and/or any other broker/agent communication devices 40, which may be utilized in conjunction with the apparatus 100 of the present invention.

The broker/agent communication device 40 also includes a database(s) 40H. The database 40H can contain and/or be linked to any of the data and/or information described herein as being stored in the database 10H.

The database 40H can also contain or include any data and/or information which may be needed or required, and/or which may be desired, for performing any of the functionality and/or processing routines described herein as being performed by the broker/agent communication device 40. In a preferred embodiment, the database 40H can also include any data and/or information regarding any owners, of any of the here-described real estate assets and/or high value assets, as well as information regarding each owner's respective real estate asset(s) and/or high value asset(s), who or which are represented by the broker or agent, or any agent or employee of same, who utilizes the broker/agent communication device 40. The database 40H can also include any data, information, information regarding products and/or services provided by the broker or agent, who utilizes the broker/agent communication device 40, which are offered by, or provided by the broker or agent. The database 40H can also include any and/or all software programs or software applications which are needed, required, or desired, for generating, producing, and/or providing, any and/or all of the information and/or which can be provided by the broker/agent communication device 40.

The database 40H can also contain or include any data and/or information described herein as being contained in the respective databases of the central processing computer(s) 10, the user communication devices 20, the governmental entity computers 30, the service provider communication devices 50, the information/analytics provider computers 60, the financial institution computers 70, and/or any other broker/agent communication devices 40. The database 40H can also be connected to the CPU 40A.

The broker/agent communication device 40 also includes an output device 401 for outputting any of the data, information, and/or reports, described herein as being generated by or via the broker/agent communication device 40. In the preferred embodiment, the output device 401 can be a printer, a display, a transmitter, a modem, and/or any other device which can be used to output data or information of any kind or type.

The broker/agent communication device 40 also includes a video and/or audio recording device(s) 40J which can include a camera and/or a video recording device for recording pictures or video and/or video clips and/or a microphone or an audio recording device for recording audio or audio clips which can be recorded by, and/or transmitted live, by or from the broker/agent communication device 40, or which can be recorded by, and stored at or in, the broker/agent communication device 40 for transmission by or from the broker/agent communication device 40 at a later time. The video and/or audio recording device(s) 40J can also be utilized to facilitate one-way broadcasts from the broker/agent communication device 40, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the broker/agent communication device 40 can engage in telephone calls and video conferencing calls via the same. The user of the broker/agent communication device 40 can also use the video and/or audio recording device(s) 40J to record and broadcast or transmit content via its transmitter 40F.

With reference to FIG. 5, the broker/agent communication device 40, in the preferred embodiment, also includes a global positioning device 40K for determining the position or location of the broker/agent communication device 40. In a preferred embodiment, the global positioning device 40K can be utilized to determine the position or location of broker/agent communication device 40 so as to, for example, determine a municipality, political subdivision, or jurisdiction, in which the broker/agent communication device 40 is located at any time.

For example, if the broker/agent communication device 40 is at a fixed location, or is moving, the global positioning device 40K can determine the position or location of the broker/agent communication device 40 at the time or instant the same is being utilized. The global positioning device 40K can also be utilized to determine where the broker/agent communication device 40 is located at any given time. The global positioning device 40K can also be connected with the CPU 40A.

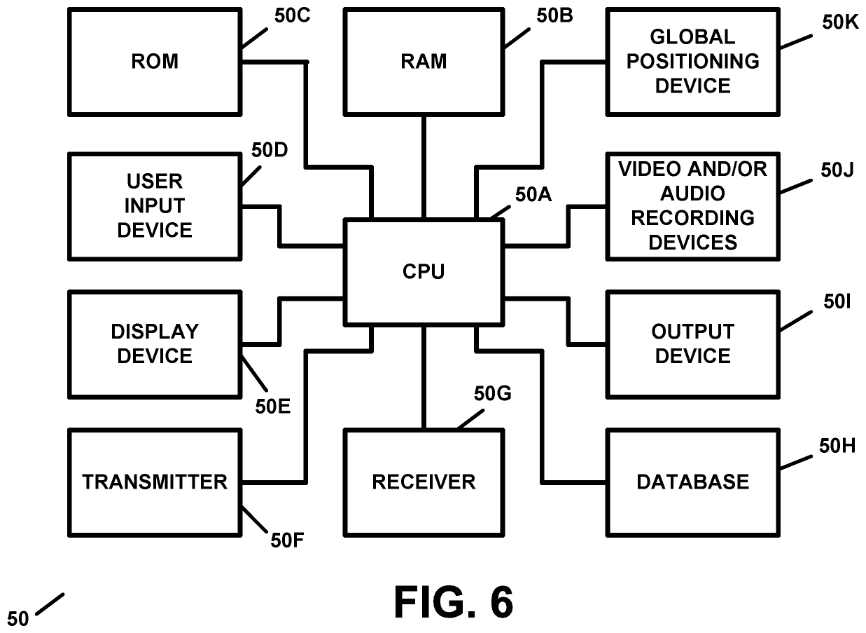

FIG. 6 illustrates the service provider communication device 50 of FIG. 1, in block diagram form. The service provider communication device 50, in the preferred embodiment, can be a computer, a server computer, a computer terminal or a terminal device connected to a computer or a server computer, a personal computer, a home computer, a personal communication device, a telephone, an interactive television, a smart phone, a cellular telephone, a wireless telephone, a videophone, a video telephone, a personal digital assistant, a watch, a smart watch, a VR (virtual reality) headset or interface, an AR (augmented reality) headset or interface, a wearable communication device, glasses equipped with communications equipment, a beeper or a pager, or any other communication device or equipment. The service provider communication device 50 can also be any computer capable of being utilized in a network.

With reference to FIG. 6, in the preferred embodiment, the service provider communication device 50 includes a central processing unit or CPU 50A which, in the preferred embodiment, is a microprocessor. The CPU 50A may also be a microcomputer, a minicomputer, a macro-computer, and/or a mainframe computer, depending upon the application. The CPU 50A is specially programmed and/or specially configured to perform any and/or all of the functionality described herein as being performed by the service provider communication device 50.

The service provider communication device 50 also includes a random access memory (RAM) device(s) 50B and a read only (ROM) memory device(s) 50C, each of which is connected to the CPU 50A, and a user input device 50D, for entering data or information and/or instructions and/or commands into the service provider communication device 50. The user input device 50D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the service provider communication device 50. The input device(s) 50D is/are also connected to the CPU 50A.

The service provider communication device 50 also includes a display device 50E for displaying data and/or information to a user. The service provider communication device 50 also includes a transmitter(s) 50F, for transmitting signals and/or data and/or information to any one or more of the central processing computers 10, the user communication devices 20, the governmental entity computers 30, the broker/agent communication devices 40, the information/analytics provider computers 60, the financial institution computers 70, and/or any other service provider communication devices 50, which may be utilized in conjunction with the apparatus 100 of the present invention. The service provider communication device 50, also includes a receiver 50G, for receiving signals and/or data and/or information from any one or more of the central processing computers 10, the user communication devices 20, the governmental entity computers 30, the broker/agent communication devices 40, the information/analytics provider computers 60, the financial institution computers 70, and/or any other service provider communication devices 50, which may be utilized in conjunction with the apparatus 100 of the present invention.

The service provider communication device 50 also includes a database(s) 50H. The database 50H can contain and/or be linked to any of the data and/or information described herein as being stored in the database 10H.

The database 50H can also contain or include any data and/or information which may be needed or required, and/or which may be desired, for performing any of the functionality and/or processing routines described herein as being performed by the service provider communication device 50. In a preferred embodiment, the database 50H can also include any data and/or information regarding any owners, of any of the here-described real estate assets and/or high value assets, as well as information regarding each owner's respective real estate asset(s) and/or high value asset(s), to or for whom the service provider, who utilizes the service provider communication device 50, provides services. The database 50H can also include any data, information, information regarding products and/or services provided by the service provider who or which utilizes the service provider communication device 50, which are offered by, or provided by the service provider. The database 50H can also include any and/or all software programs or software applications which are needed, required, or desired, for generating, producing, and/or providing, any and/or all of the information and/or services which can be provided by the service provider communication device 50.

The database 50H can also contain or include any data and/or information described herein as being contained in the respective databases of the central processing computer(s) 10, the user communication devices 20, the governmental entity computers 30, the broker/agent communication devices 40, the information/analytics provider computers 60, the financial institution computers 70, and/or any other service provider communication devices 50. The database 50H can also be connected to the CPU 50A.

The service provider communication device 50 also includes an output device 501 for outputting any of the data, information, and/or reports, described herein as being generated by or via the service provider communication device 50. In the preferred embodiment, the output device 501 can be a printer, a display, a transmitter, a modem, and/or any other device which can be used to output data or information of any kind or type.

The service provider communication device 50 also includes a video and/or audio recording device(s) 50J which can include a camera and/or a video recording device for recording pictures or video and/or video clips and/or a microphone or an audio recording device for recording audio or audio clips which can be recorded by, and/or transmitted live, by or from the service provider communication device 50, or which can be recorded by, and stored at or in, the service provider communication device 50 for transmission by or from the service provider communication device 50 at a later time. The video and/or audio recording device(s) 50J can also be utilized to facilitate one-way broadcasts from the service provider communication device 50, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the service provider communication device 50 can engage in telephone calls and video conferencing calls via the same. The user of the service provider communication device 50 can also use the video and/or audio recording device(s) 50J to record and broadcast or transmit content via its transmitter 50F.

With reference to FIG. 6, the service provider communication device 50, in the preferred embodiment, also includes a global positioning device 50K for determining the position or location of the service provider communication device 50. In a preferred embodiment, the global positioning device 50K can be utilized to determine the position or location of the service provider communication device 50 so as to, for example, determine a municipality, political subdivision, or jurisdiction, in which the service provider communication device 50 is located at any time.

For example, if the service provider communication device 50 is at a fixed location, or is moving, the global positioning device 50K can determine the position or location of the service provider communication device 50 at the time or instant the same is being utilized. The global positioning device 50K can also be utilized to determine where service provider communication device 50 is located at any given time. The global positioning device 50K can also be connected with the CPU 50A.

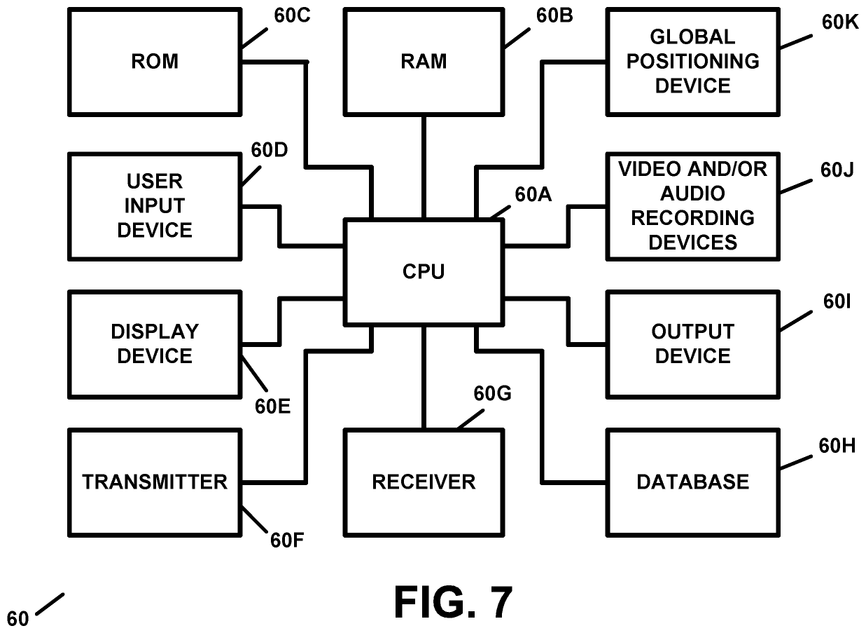

FIG. 7 illustrates the information/analytics provider computer 60 of FIG. 1, in block diagram form. The information/analytics provider computer 60, in the preferred embodiment, can be a computer, a server computer, a computer terminal or a terminal device connected to a computer or a server computer, a personal computer, a home computer, a personal communication device, a telephone, an interactive television, a smart phone, a cellular telephone, a wireless telephone, a videophone, a video telephone, a personal digital assistant, a watch, a smart watch, a VR (virtual reality) headset or interface, an AR (augmented reality) headset or interface, a wearable communication device, glasses equipped with communications equipment, a beeper or a pager, or any other communication device or equipment. The information/analytics provider computer 60 can also be any computer capable of being utilized in a network.

With reference to FIG. 7, in the preferred embodiment, the information/analytics provider computer 60 includes a central processing unit or CPU 60A which, in the preferred embodiment, is a microprocessor. The CPU 60A may also be a microcomputer, a minicomputer, a macro-computer, and/or a mainframe computer, depending upon the application. The CPU 60A is specially programmed and/or specially configured to perform any and/or all of the functionality described herein as being performed by the information/analytics provider computer 60.

The information/analytics provider computer 60 also includes a random access memory (RAM) device(s) 60B and a read only (ROM) memory device(s) 60C, each of which is connected to the CPU 60A, and a user input device 60D, for entering data or information and/or instructions and/or commands into the information/analytics provider computer 60. The user input device 60D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the information/analytics provider computer 60. The input device(s) 60D is/are also connected to the CPU 60A.

The information/analytics provider computer 60 also includes a display device 60E for displaying data and/or information to a user. The information/analytics provider computer 60 also includes a transmitter(s) 60F, for transmitting signals and/or data and/or information to any one or more of the central processing computers 10, the user communication devices 20, the governmental entity computers 30, the broker/agent communication devices 40, the service provider communication devices 50, financial institution computers 70, and/or any other information/analytics provider computers 60, which may be utilized in conjunction with the apparatus 100 of the present invention. The information/analytics provider computer 60 also includes a receiver 60G, for receiving signals and/or data and/or information from any one or more of the central processing computers 10, the user communication devices 20, the governmental entity computers 30, the broker/agent communication devices 40, the service provider communication devices 50, the financial institution computers 70, and/or any other information/analytics provider computers 60, which may be utilized in conjunction with the apparatus 100 of the present invention.

The information/analytics provider computer 60 also includes a database(s) 60H. The database 60H can contain and/or be linked to any of the data and/or information described herein as being stored in the database 10H.

The database 60H can also contain or include any data and/or information which may be needed or required, and/or which may be desired, for performing any of the functionality and/or processing routines described herein as being performed by the information/analytics provider computer 60. In a preferred embodiment, the database 60H can also include any of the information and/or analytics products which can generated and/or provided by the information/analytics provider computer 60 as well can include any and/or all software programs or software applications which are needed, required, or desired, for generating, producing, and/or providing, any and/or all of the information and/or analytics products and/or services which can be provided by the information/analytics provider computer 60.

The database 60H can also contain or include any data and/or information described herein as being contained in the respective databases of the central processing computer(s) 10, the user communication devices 20, the governmental entity computers 30, the broker/agent communication devices 40, the service provider communication devices 50, the financial institution computers 70, and/or any other information/analytics provider computers 60. The database 60H can also be connected to the CPU 60A.

The information/analytics provider computer 60 also includes an output device 601 for outputting any of the data, information, and/or reports, described herein as being generated by or via the information/analytics provider computer 60. In the preferred embodiment, the output device 601 can be a printer, a display, a transmitter, a modem, and/or any other device which can be used to output data or information of any kind or type.

The information/analytics provider computer 60 also includes a video and/or audio recording device(s) 60J which can include a camera and/or a video recording device for recording pictures or video and/or video clips and/or a microphone or an audio recording device for recording audio or audio clips which can be recorded by, and/or transmitted live, by or from the information/analytics provider computer 60, or which can be recorded by, and stored at or in, the information/analytics provider computer 60 for transmission by or from the information/analytics provider computer 60 at a later time. The video and/or audio recording device(s) 60J can also be utilized to facilitate one-way broadcasts from the information/analytics provider computer 60, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the information/analytics provider computer 60 can engage in telephone calls and video conferencing calls via the same. The user of the information/analytics provider computer 60 can also use the video and/or audio recording device(s) 60J to record and broadcast or transmit content via its transmitter 60F.

With reference to FIG. 7, the information/analytics provider computer 60, in the preferred embodiment, also includes a global positioning device 60K for determining the position or location of the information/analytics provider computer 60. In a preferred embodiment, the global positioning device 60K can be utilized to determine the position or location of the information/analytics provider computer 60 so as to, for example, determine a municipality, political subdivision, or jurisdiction, in which the information/analytics provider computer 60 is located at any time.

For example, if the information/analytics provider computer 60 is at a fixed location, or is moving, the global positioning device 60K can determine the position or location of the information/analytics provider computer 60 at the time or instant the same is being utilized. The global positioning device 60K can also be utilized to determine where the information/analytics provider computer 60 is located at any given time. The global positioning device 60K can also be connected with the CPU 60A.

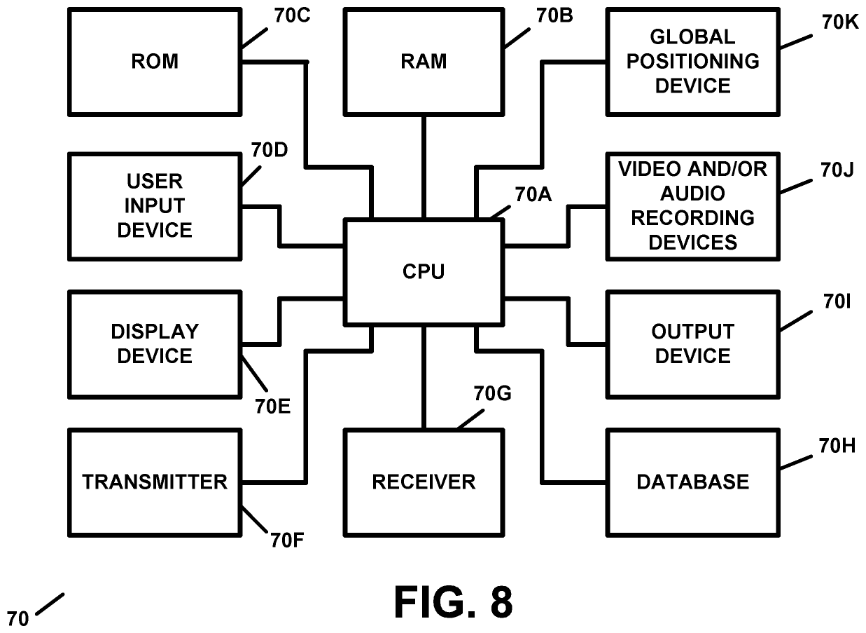

FIG. 8 illustrates the financial institution computer 70 of FIG. 1, in block diagram form. The financial institution computer 70, in the preferred embodiment, can be a computer, a server computer, a computer terminal or a terminal device connected to a computer or a server computer, a personal computer, a home computer, a personal communication device, a telephone, an interactive television, a smart phone, a cellular telephone, a wireless telephone, a videophone, a video telephone, a personal digital assistant, a watch, a smart watch, a VR (virtual reality) headset or interface, an AR (augmented reality) headset or interface, a wearable communication device, glasses equipped with communications equipment, a beeper or a pager, or any other communication device or equipment. The financial institution computer 70 can also be any computer capable of being utilized in a network.

With reference to FIG. 8, in the preferred embodiment, the financial institution computer 70 includes a central processing unit or CPU 70A which, in the preferred embodiment, is a microprocessor. The CPU 70A may also be a microcomputer, a minicomputer, a macro-computer, and/or a mainframe computer, depending upon the application. The CPU 70A is specially programmed and/or specially configured to perform any and/or all of the functionality described herein as being performed by the financial institution computer 70.

The financial institution computer 70 also includes a random access memory (RAM) device(s) 70B and a read only (ROM) memory device(s) 70C, each of which is connected to the CPU 70A, and a user input device 70D, for entering data or information and/or instructions and/or commands into the financial institution computer 70. The user input device 70D can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, or instructions and/or commands, to be entered into the financial institution computer 70. The input device(s) 70D is/are also connected to the CPU 70A.

The financial institution computer 70 also includes a display device 70E for displaying data and/or information to a user. The financial institution computer 70 also includes a transmitter(s) 70F, for transmitting signals and/or data and/or information to any one or more of the central processing computers 10, the user communication devices 20, the governmental entity computers 30, the broker/agent communication devices 40, the service provider communication devices 50, the information/analytics provider computers 60, and/or any other financial institution computers 70, which may be utilized in conjunction with the apparatus 100 of the present invention. The financial institution computer 70 also includes a receiver 70G, for receiving signals and/or data and/or information from any one or more of the central processing computers 10, the user communication devices 20, the governmental entity computers 30, the broker/agent communication devices 40, the service provider communication devices 50, the information/analytics provider computers 60, and/or any other the financial institution computers 70, which may be utilized in conjunction with the apparatus 100 of the present invention.

The financial institution computer 70 also includes a database(s) 70H. The database 70H can contain and/or be linked to any of the data and/or information described herein as being stored in the database 10H.

The database 70H can also contain any data and/or information which may be needed or required, and/or which may be desired, for performing any of the functionality and/or processing routines described herein as being performed by the financial institution computer 70. In a preferred embodiment, the database 70H can also include any of the data and/or information described herein as being contained in the respective databases of the central processing computer(s) 10, the user communication devices 20, the governmental entity computers 30, the broker/agent communication devices 40, the service provider communication devices 50, the information/analytics provider computers 60, and/or any other financial institution computers 70. The database 70H can also be connected to the CPU 70A.

The financial institution computer 70 also includes an output device 701 for outputting any of the data, information, and/or reports, described herein as being generated by or via the financial institution computer 70. In the preferred embodiment, the output device 701 can be a printer, a display, a transmitter, a modem, and/or any other device which can be used to output data or information of any kind or type.

The financial institution computer 70 also includes a video and/or audio recording device(s) 70J which can include a camera and/or a video recording device for recording pictures or video and/or video clips and/or a microphone or an audio recording device for recording audio or audio clips which can be recorded by, and/or transmitted live, by or from the financial institution computer 70, or which can be recorded by, and stored at or in, the financial institution computer 70 for transmission by or from the financial institution computer 70 at a later time. The video and/or audio recording device(s) 70J can also be utilized to facilitate one-way broadcasts from the financial institution computer 70, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the financial institution computer 70 can engage in telephone calls and video conferencing calls via the same. The user of the financial institution computer 70 can also use the video and/or audio recording device(s) 70J to record and broadcast or transmit content via its transmitter 70F.

With reference to FIG. 8, the financial institution computer 70, in the preferred embodiment, also includes a global positioning device 70K for determining the position or location of the financial institution computer 70. In a preferred embodiment, the global positioning device 70K can be utilized to determine the position or location of the financial institution computer 70 so as to, for example, determine a municipality, political subdivision, or jurisdiction, in which the financial institution computer 70 is located at any time.

For example, if the financial institution computer 70 is at a fixed location, or is moving, the global positioning device 70K can determine the position or location of the financial institution computer 70 at the time or instant the same is being utilized. The global positioning device 70K can also be utilized to determine where the financial institution computer 70 is located at any given time. The global positioning device 70K can also be connected with the CPU 70A.

The apparatus 100 and methods of the present invention can be utilized to allow any user to search for, express an interest, and/or seek to purchase, any real estate asset of public record, any real estate asset listed as being offered for sale or being available for sale, any high value asset of any type or kind which is of public record, and/or any high value asset listed as being offered for sale or being available for sale. The apparatus 100 and methods of the present invention can also be utilized to allow any owner of any real estate asset of public record, any real estate asset listed as being offered for sale or being available for sale, any high value asset of any type or kind which is of public record, and/or any high value asset listed as being offered for sale or being available for sale, to obtain and/or to be provided with information regarding users or prospective purchasers who are or may be interested in purchasing their respective real estate asset or high value asset, and/or any offers to purchase their respective real estate asset or high value asset.

In a preferred embodiment, all users of the apparatus 100, which can include individual users or business entities, can create a user profile which can be stored in the database 10H of the central processing computer. In a preferred embodiment, users can include owners of any of the herein-described real estate assets and/or owners of any of the herein-described high value assets. Each real estate asset can have a real estate asset profile associated therewith or assigned thereto and each high value asset can has a high value asset profile associated therewith or assigned thereto. In a preferred embodiment, the user profiles, real estate profiles, and high value asset profiles, can be stored in the database 10H of the central processing computer 10.

In a preferred embodiment, each user profile can contain and/or include information regarding the name, address, email address, telephone number, cellular telephone number, a text messaging number, an SMS messaging number, an instant messaging ID, a picture or photograph of the user, a description or biographical information by the user, any occupation information, if desired, any information regarding interests or hobbies, if desired, and/or any other information which the user wants to add about himself, herself, or itself, any video conferencing ID information such, for example, but not limited to any video conferencing service or application and/or any videoconferencing services or applications, and/or any video chat room service(s) or application(s). In a preferred embodiment, the user profile can also contain a link of hyperlink to and/or for allowing any other user or owner to call, send an email to, send a text message, an SMS message, or an instant message, to, text message, and/or initiate a video conference with, and/or to communicate with or send a message to, the user via the user's user profile.

In the preferred embodiment, the user can also specify, in instances when the user may be a prospective purchaser, they he, she, or it, is pre-certified or pre-authorized to obtain a mortgage to purchase a real estate asset or a loan for a high value asset. In the preferred embodiment, the user, in instances when the user may be a prospective purchaser, can also request to receive an alert message or a notification message if and when a real estate asset in a certain location is offered for sale, or if another user makes an offer to purchase a real estate asset the user may have indicated that he, she, or it, is interested in purchasing regardless of whether the real estate asset is currently being offered for sale, and/or upon the occurrence of any other specified event.

In the preferred embodiment, the user, in instances when the user may be a prospective purchaser, can also request to receive an alert message or a notification message if and when a high value asset is offered for sale, or if another user makes an offer to purchase a high value asset that the user may have indicated that he, she, or it, is interested in purchasing regardless of whether the high value asset is currently being offered for sale, and/or upon the occurrence of any other specified event.

In the preferred embodiment, the user can also specify, in instances when the user may be an owner of a real estate asset or of a high value asset, to receive an alert message or a notification message if and when another user, who may be a prospective purchaser, has indicated or registered an interest in purchasing a real estate asset in a price range in which the owner may be interested in selling his, her, or its, real estate asset and/or that another user, who may be a prospective purchaser, has indicated or registered an interest in purchasing a high value asset in a price range in which the owner may be interested in selling his, her, or its, high value asset. In the preferred embodiment, the user can also specify, in instances when the user may be an owner of a real estate asset or a high value asset that he, she, or it, receive an alert message or a notification message upon the occurrence of other pre-specified event.

In a preferred embodiment, the user profile can be created, edited, and/or updated, at any time by the user or a person authorized by the user. Any data and/or information contained in, and any and/or all, user profiles described herein can be stored in the database 10H.

In a preferred embodiment, a real estate asset profile can contain information regarding a description of the real estate asset, the address of the real estate asset, the municipality of the real estate asset, the record owner of the real estate asset, annual property taxes for the real estate asset, price history of past transactions of the real estate asset, property tax history for the real estate asset, any survey of or for the real estate asset, layout or floor plan, any blueprints for any building(s) situated on the real estate asset, zoning information, certificate of occupancy or certificates of occupancy, any permit applications, any permits, any offering prices and/or offering terms, if already listed for sale, a photograph or more than one photographs of the real estate asset, a video presentation, a virtual tour, a 3-dimensional (3D) video presentation, a 3D virtual tour, a virtual reality (VR) video presentation, a VR virtual tour, an augmented reality (AR) video presentation, and/or an AR virtual tour, and/or any link and/or hyperlink to same, for the real estate asset, and/or any other information regarding the real estate asset that a prospective purchaser might be interested in when considering to purchase the real estate asset, and/or any link and/or hyperlink to same, and/or any information regarding the real estate asset that an owner may want or need to provide when attempting to sell a real estate asset, and/or any links and/or hyperlinks to same.

In a preferred embodiment, the real estate asset profile can also include information regarding whether or not the real estate asset is currently being offered for sale, the name(s) of any user or users who have indicated an interest in the real estate asset if it is currently being offered for sale, along with information regarding the amount of any purchase offer for the real estate asset made by any user or users, and the name(s) of any user or users who have indicated an interest in the real estate asset even if it is not currently being offered for sale, along with information regarding the amount of any purchase offer for the real estate asset made by any user or users.

With regards to a residential real estate asset, the real estate asset profile can also contain information regarding square footage of a house, number of bedrooms, number of bathrooms, a basement, an attic, a garage, improvements, recent improvements, additions, renovations, type of heating, type of air conditioning, estimates fuel costs, estimated heating costs, estimated utilities costs, rent roll, if a multi-family dwelling, and/or any other information which can be required or desired to provide and/or to advertise when selling a residential real estate asset, and/or any links and/or hyperlinks to same.

With regards to a commercial real estate asset, the real estate asset profile can also contain information regarding square footage of the same, a basement, an attic, a garage, improvements, recent improvements, additions, renovations, type of heating, type of air conditioning, estimates fuel costs, estimated heating costs, estimated utilities costs, rent roll, and/or any other information which can be required or desired to provide and/or to advertise when selling a commercial real estate asset, and/or any links and/or hyperlinks to same.

In a preferred embodiment, the owner of a real estate asset can, at any time, add and/or edit information regarding his, her, or its, real estate asset. In a preferred embodiment, a real estate asset profile can be automatically created for each real estate asset, containing at least minimal information regarding the real estate asset, in the first instance. The owner of the real estate asset can then register as the owner of the same and, thereafter, add information to, and/or edit information in, the real estate asset profile at any time. In the preferred embodiment, the owner can also add information regarding his, her, or its, real estate asset as well as upload documents such as copies of blueprints, floor plans, surveys, certificates of occupancy, building permits, appraisals, inspection reports, title searches, deeds, titles, contracts, and/or any other document(s) which may be of interest in marketing and/or selling the real estate asset.

The real estate profile can also contain information regarding any and/or all users and/or prospective purchasers who have indicated or registered an interest in purchasing the real estate asset and/or an offer price the individual would be interested in paying for, or offering to purchase, the real estate asset. In a preferred embodiment, the real estate asset profile can contain information and/or information sections which can be entered and/or updated by any user. For example, any user can enter information regarding his or her interest in a real estate asset and/or can enter information regarding an offer to purchase, and/or an amount of a purchase offer, into the real estate asset profile.

The database 10H of the central processing computer 10 can store information for or regarding any and/or all of the herein-described real estate asset profiles.

In a preferred embodiment, a high value asset profile can contain information regarding a description of the high value asset, the owner of the high value asset, the address of the owner of the high value asset, the record owner of the high value asset, price history of past transactions of the high value asset, any offering prices and/or offering terms, if already listed for sale, a photograph or more than one photographs of the high value asset, a video presentation, a virtual tour, a 3-dimensional (3D) video presentation, a 3D virtual tour, a virtual reality (VR) video presentation, a VR virtual tour, an augmented reality (AR) video presentation, and/or an AR virtual tour, and/or any link and/or hyperlink to same, for the high value asset, and/or any other information regarding the high value asset that a prospective purchaser might be interested in when considering to purchase the high value asset, and/or any link and/or hyperlink to same, and/or any information regarding the high value asset that an owner may want or need to provide when attempting to sell a high value asset, and/or any links and/or hyperlinks to same.

In a preferred embodiment, the high value asset profile can also include information regarding whether or not the high value asset is currently being offered for sale, the name(s) of any user or users who have indicated an interest in the high value asset if it is currently being offered for sale, along with information regarding the amount of any purchase offer for the high value asset made by any user or users, and the name(s) of any user or users who have indicated an interest in the high value asset even if it is not currently being offered for sale, and information regarding the amount of any purchase offer for the high value asset made by any user or users.

In a preferred embodiment, the owner of a high value asset can, at any time, create a high value asset profile for his, her, or its, high value asset, by registering same with the apparatus 100. The owner of the high value asset can then register as the owner of the same and, thereafter, add information to, and/or edit information in, the high value asset profile at any time. In the preferred embodiment, the owner can also add information regarding his, her, or its, high value asset as well as upload pictures and/or video recordings and/or documents such as titles, appraisals, valuations, inspection reports, contracts, and/or any other document(s) which may be of interest in marketing and/or selling the high value asset.

The high value asset profile can also contain information regarding any and/or all users and/or prospective purchasers who have indicated or registered an interest in purchasing the high value asset and/or an offer price the individual would be interested in paying for, or offering to purchase, the high value asset. The owner of the high value asset can thereafter, add information to, and/or edit information in, the high value asset profile at any time. In a preferred embodiment, the high value asset profile can contain information and/or information sections which can be entered and/or updated by any user. For example, any user can enter information regarding his or her interest in a high value estate asset and/or can enter information regarding an offer to purchase, and/or an amount of a purchase offer, into the high value asset profile.

The database 10H of the central processing computer 10 can store information for or regarding any and/or all of the herein-described high value asset profiles.

In a preferred embodiment, the apparatus 100, can, in the case of real estate assets, allow a user to search for real estates assets from among any and/or all real estate assets which are of public record, by address, by municipality, by political subdivision, or by zip code. The apparatus 100 can also allow a user to search for real estate assets from among any and/or all real state assets, which may or may not be of public record but which are listed for sale, by address, by municipality, by political subdivision, or by zip code. In a preferred embodiment, once a user searches for real estate assets, by municipality, political subdivision, or zip code, the apparatus 100 will transmit and/or provide a map of the desired or selected address, municipality, political subdivision, or zip code, to the user communication device 20 being utilized by the user. The map can be displayed via the display device 20E. In a preferred embodiment, the map can show any real estate asset of the desired address and/or any and/or all real estate assets of public record and/or which are listed for sale in the desired or selected municipality, political subdivision, or zip code. The map can show all real estate asset plots of real estate and all real estate assets from a top view perspective, can provide a street map or other elevation view of the same, and/or can provide an aerial and/or a satellite view of the same. The user, in a preferred embodiment, can enlarge, or zoom in, on any real estate asset and/or on any portion or portions of the map. If interested in a real estate asset, the user can select to obtain and/or view information regarding the same.

If the user selects a real estate asset in order to obtain and/or to view information regarding the same, the apparatus 100, in a preferred embodiment, will provide and/or transmit the real estate asset profile to the user communication device 20 in and/or as part of an electronic forum. In a preferred embodiment, the electronic forum can be displayed on and/or via the display device 20E of the user communication device 20. In the preferred embodiment, the electronic forum can provide the user with the real estate asset profile, a link(s) or hyperlink(s) to any of the herein-described contact information of or for the owner of the real estate asset, so that the user can communicate and/or otherwise make contact with the owner of the real estate asset, a link(s) or hyperlink(s) to the governmental entity computer 30 associated with the municipality or political subdivision in which the real estate asset is situated, so that the user can request and/or obtain any desired or needed information of public record for the real estate asset, and a link(s) or hyperlink(s) to a broker/agent communication device 40 associated with a buyer's broker or an buyer's agent, so that the user can communicate with and/or engage the services of the buyer's broker or an buyer's agent for or regarding the real estate asset, and/or a link(s) or hyperlink(s) to a service provider computer(s) 50 associated with any one of more types or kinds of service providers, such as for example, but not limited to an attorney, an inspection engineer, a surveyor, an architect, a tax certiorari professional, a construction company or entity, a home improvement professional or entity, and/or any other service provider who or which can provide any service to the user in order to allow the user to contact and/or communicate with any service provider for any reason.

In the preferred embodiment, the electronic forum can also provide the user with a link(s) or hyperlink(s) to the information/analytics provider computer(s) 60 associated with an information/analytics provider(s), so that the user can communicate with an information/analytics provider in order to obtain information and/or analytics information, such as, for example, but not limited to, valuation information regarding the real estate asset, comparable sales prices for the real estate asset, and/or any other data and/or information and/or analytics information which an information/analytics provider can provide to the user, and/or a link(s) or hyperlink(s) to the financial institution computer(s) 70 associated with a financial institution(s), so that the user can communicate with one or more financial institutions to obtain information regarding any products or services offered by the same, and/or for any reason or purpose.

In another preferred embodiment, the apparatus 100 of the present invention can also be utilized to allow a user to search for any high value asset or high value assets which are registered with the apparatus. In a preferred embodiment, the user can search for a high value assets or high valued assets by using any descriptive key word or key words. In a preferred embodiment, once a user searches for high value assets, the apparatus 100 will transmit and/or provide a results page to the user communication device 20 being utilized by the user. The results page can be displayed via the display device 20E. In a preferred embodiment, the results page can show any value assets which satisfy the search criteria of the user. The user can then select a high value asset listed on the results page.

If the user selects a high value asset in order to obtain and/or to view information regarding the same, the apparatus 100, in a preferred embodiment, will provide and/or transmit the high value asset profile to the user communication device 20 in and/or as part of an electronic forum. In a preferred embodiment, the electronic forum can be displayed on and/or via the display device 20E of the user communication device 20. In the preferred embodiment, the electronic forum can also provide the user with the high value asset profile, a link(s) or hyperlink(s) to any of the herein-described contact information of or for the owner of the high value asset, so that the user can communicate and/or otherwise make contact with the owner of the high value asset.

In a preferred embodiment, as with real estate assets, the electronic forum can contain a link(s) or hyperlink(s) to any governmental entity computer 30 associated with any municipality or political subdivision associated with the high value asset, so that the user can request and/or obtain any desired or needed information of public record for the high value asset, a link(s) or hyperlink(s) to a broker/agent communication device 40 associated with a buyer's broker or an buyer's agent, so that the user can communicate with and/or engage the services of the buyer's broker or an buyer's agent for or regarding the high value asset, and/or a link(s) or hyperlink(s) to a service provider computer(s) 50 associated with any one of more types or kinds of service providers who or which might be able to provide a needed or desired service for or regarding the high value asset.

In the preferred embodiment, the electronic forum can also provide the user with a link(s) or hyperlink(s) to the information/analytics provider computer(s) 60 associated with an information/analytics provider(s), so that the user can communicate with an information/analytics provider in order to obtain information and/or analytics information regarding the high value asset, and/or a link(s) or hyperlink(s) to the financial institution computer(s) 70 associated with a financial institution(s), so that the user can communicate with one or more financial institutions to obtain information regarding any products or services offered by the same, and/or for any other reason or purpose.

The apparatus 100 and methods of the present invention can be utilized, in a number of preferred embodiments, in order to allow users and prospective buyers to search for, identify, indicate an interest to purchase or to obtain information regarding, make an offer to purchase, and/or otherwise interact with and/or engage with owners, of real estate assets and/or high value assets.

The apparatus 100 and methods of the present invention can also be utilized, in a number of preferred embodiments, in order to allow prospective renters or lessees to search for, identify, indicate an interest to rent or lease or to obtain information regarding, make an offer to rent or lease, and/or otherwise interact with and/or engage with owners, of real estate assets and/or high value assets.

In a preferred embodiment, any user, who or which can be any natural person, individual, or entity, who or which owns a real estate asset or a high value asset, who or which is a prospective purchaser or a potential purchaser of a real estate asset or a high value asset, and/or who or which may desire to utilize the apparatus 100 of the present invention for any reason or purpose, can utilize the apparatus 100 and methods of the present invention. In a preferred embodiment, the user can create a user profile which can include any data and/or information which is described herein as being included in the user profile as well as any other data and/or information which may be needed or required. At any time, any user can also update or edit his, her, or its, user profile.

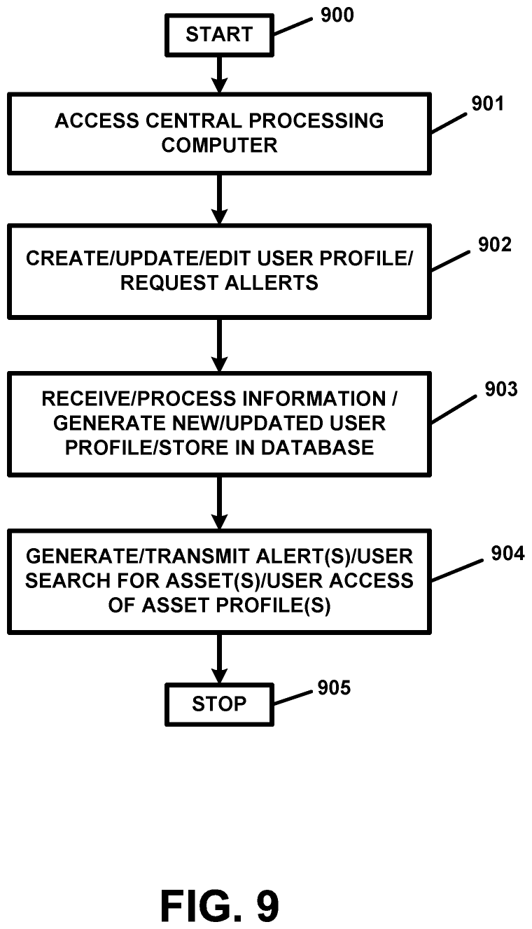

FIG. 9 illustrates a preferred embodiment method for utilizing the apparatus 100 of the present invention, in flow diagram form. With reference to FIG. 9, the operation of the apparatus 100 commences at step 900. At step 901, a user can access the central processing computer 10 by using his, her, or its user communication device 20. At step 902, the user can create his, her, or its, user profile or, if the user already has a user profile the user can update or edit his, her, or its, user profile. At step 902, the user can enter, into the user communication device 20, and transmit to the central processing computer 10, any data and/or information described herein in as being included in the user profile and/or any other information which may be needed for allowing the user to utilize the apparatus 100 of the present invention in any and/or all of the preferred embodiments described herein. At step 902, the user can also register any request to receive any of the herein-described alert messages or notification messages upon, or in response to, the occurrence of any event for which the user wants to be notified.

As and for an example, a user who or which is or may be a prospective purchase can request to be notified when a real estate asset or a high value asset is offered for sale, when a real estate asset or a high value asset is offered for sale within pre-specified price range, when interest or an offer is made for a real estate asset or a high value asset of a pre-specified type or kind and whether the respective real estate asset or a high value asset is currently being offered for sale, and/or when any other event occurs or when the posting or listing of any information indicative of such an event occurs which is of interest to the user and/or which has been pre-specified by the user.

As and for another example, a user who or which is an owner of a real estate asset or a high value asset can request to be notified of the existence of a potential purchaser for his, her, or its, asset, when an offer which has been made to purchase a real estate asset or a high value asset which is comparable or similar to the real estate asset or a high value asset owned by the user, when a real estate asset or a high value asset which is comparable or similar to the real estate asset or a high value asset owned by the user has been sold, when another user or a prospective purchaser has made an offer for or on, or has posted an offer to purchase, the real estate asset or a high value asset owned by the user, and/or when any other event occurs or when the posting or listing of any information indicative of such an event occurs which is of interest to the owner user and/or which has been pre-specified by the owner user.

At step 902, the user can enter, and transmit to the central processing computer 10, any and/or all information for creating or updating his, her, or its, user profile. At step 902, any owner can also access and update and/or edit any of his, her, or its, real estate asset profile(s) or high value asset profile(s). At step 903, the central processing computer 10 can receive, process, and/or store, any and/or all data and/or information entered and transmitted by the user at step 902. At step 903, the central processing computer 10 can, in the case of a user creating a user profile, generate and/or store the newly created user profile in the central processing computer 10 and/or in the database 10H, and/or in the case of a user updating or editing his, her, or its, user profile, the central processing computer 10 can generate and/or store the updated user profile in the central processing computer 10 and/or in the database 10H, and/or in the case of a user updating or editing his, her, or its, real estate asset profile(s) or high value asset profile(s), the central processing computer 10 can store the updated real estate asset profile(s) or high value asset profile(s) in the central processing computer 10 and/or in the database 10H.

Thereafter, the operation of the apparatus 100 will proceed to step 904 and the central processing computer 10 can generate and transmit any alert message(s) or notification message(s) to the respective user communication device(s) 20 of any other user requesting the same based on any event triggered by the creation or updating of the user profile. Thereafter, at step 904, the user can also utilize the apparatus 100 to allow a user to either search for real estate assets or high value assets and/or allow a user to access his, her, or its, real estate asset profile or high value asset profile. At step 904, the central processing computer 10 can store any data and/or information regarding the user's use of the apparatus 100. Thereafter, the operation of the apparatus 100 will cease at step 905.

Any data and/or information, and/or any software applications, needed or desired for enabling the apparatus 100 of the present invention to operate as described in the embodiment of FIG. 9 can be stored in the database 10H, and/or in any of the other databases 20H, 30H, 40H, 50H, 60H, and/or 70H, described herein.

In a preferred embodiment, any user can utilize the apparatus 100 and methods of the present invention in order to search for a real estate asset or multiple real estate assets and/or to search for a high value asset or multiple high values assets. Upon identifying a respective real estate or high value asset, the user can select to view its respective real estate asset profile or high value asset profile. Thereafter, the user can engage in any action or activity regarding the respective real estate asset or high value asset. These actions or activities can include, but are not limited to, registering or otherwise indicating an interest in the respective real estate or high value asset, making an offer to purchase the respective real estate or high value asset whether or not the respective real estate or high value asset is currently being offered for sale, communicate with the owner of the respective real estate or high value asset, request to be notified if and/or when the respective real estate or high value asset, if not currently being offered fro sale, is offered for sale, request to be notified of the offers of other users who may make an offer to purchase the respective real estate or high value asset, and/or request to be notified if and when the owner of the respective real estate or high value asset updates any information or uploads any documents regarding the respective real estate or high value asset.

The user can also access any one or more of any one or more of the user communication device 20 of any other user and/or the owner of the respective real estate or high value asset, any one or more of the governmental entity computers 30, any one or more of the broker/agent communication devices 40, any one or more of the service provider communication devices 50, any one or more of the information/analytics provider computers 60, and/or any one or more of the financial institution computers 70, in order to obtain information from the owner of the respective real estate or high value asset, and/or to request and/or obtain information and/or services from, and/or to request and/or engage any respective services of or from, any of the herein-described governmental entities, brokers or agents, service providers, information/analytics providers, and/or financial institutions. The user can also request information from the central processing computer 10 at any time. Thereafter, any alert message(s) or notification message(s) which may be generated based on the users actions or activities can be generated and/or transmitted to the user communication devices 20 of any and/or all users who or which requested receiving such alert message(s) or notification message(s). Thereafter, the central processing computer 10 can store, in the database 10H, any and/or all information regarding the user's use of the apparatus 100 to view the respective real estate profile or high value asset profile and/or any action or activities undertaken by the user regarding or pertaining to respective real estate asset or real estate asset profile or high value asset or high value asset profile, and/or store information regarding any and/or all alert message(s) or notification message(s) transmitted by the central processing computer 10.

The user can thereafter select to view another real estate asset profile or high value asset profile or cease using the apparatus 100. If the user the desires to view another real estate asset profile or high value asset profile, then the above-described process can be repeated. If, however, the user decides to cease utilizing the apparatus 100, then the operation of the apparatus 100 can cease.

In another preferred embodiment, the apparatus 100 of FIG. 9 can be utilized in a same, a similar, and/or an analogous manner, by a prospective renter or lessee to indicate an interest in renting or leasing a real estate asset or a high value asset.

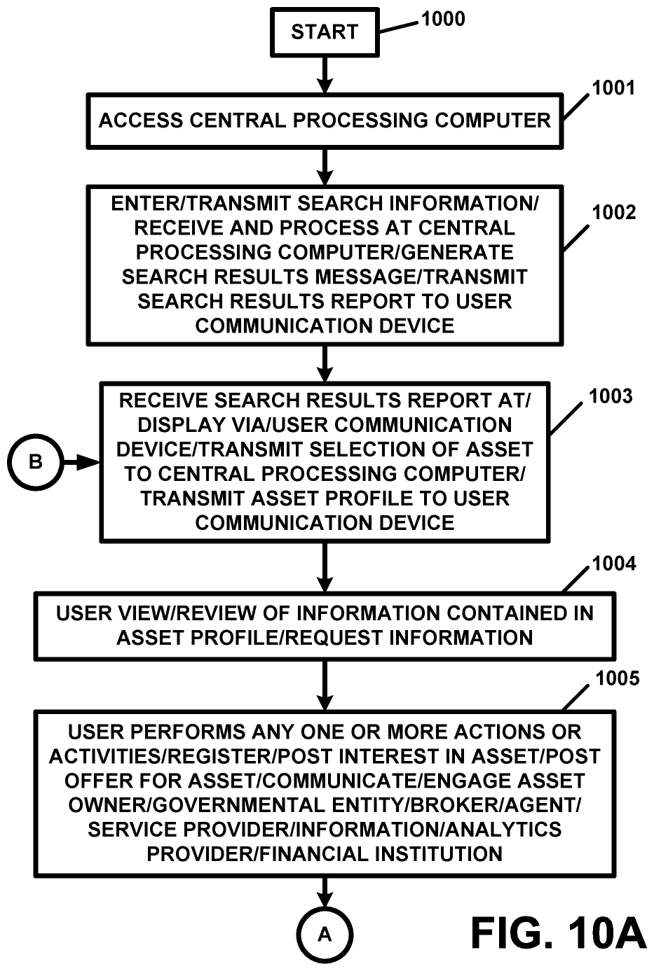

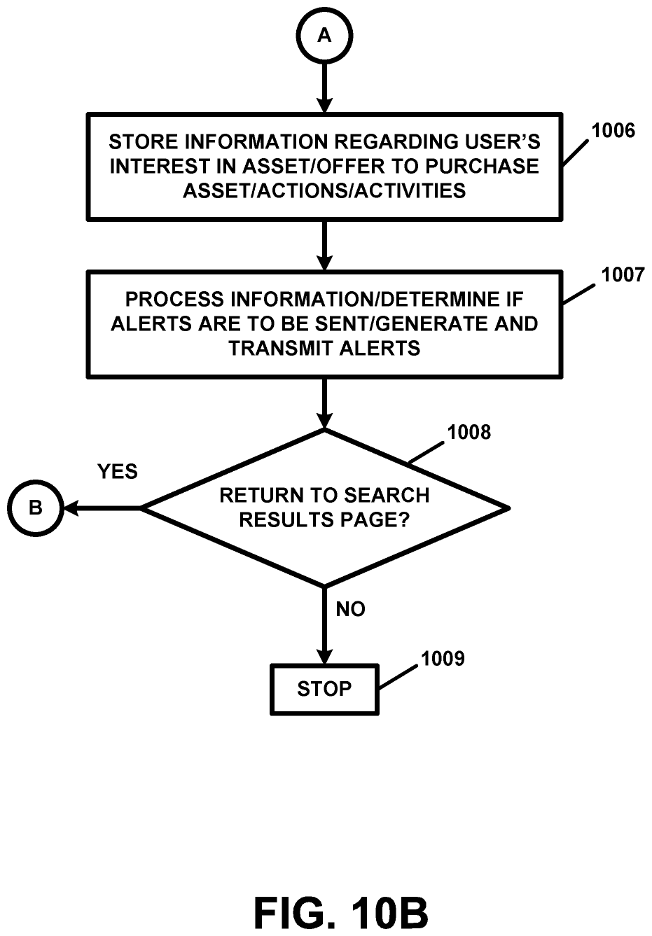

FIGS. 10A and 10B illustrate another preferred embodiment method for utilizing the apparatus 100 and methods of the present invention, in flow diagram form. With reference to FIGS. 10A and 10B, the operation of the apparatus 100 commences at step 1000. At step 1001, the user can access the central processing computer 10 with or using his or her user communication device 20. At step 1002, the user can enter search information for performing a search for a real estate asset or for multiple real estate assets, or the user can enter search information regarding a search for a high value asset or multiple high values assets. At step 1002, the search information can be transmitted from the user communication device 20 to, and received by, the central processing computer 10. At step 1002, the central processing computer can process the search information and generate a search results report. Thereafter, at step 1002, the central processing computer 10 can transmit the search report message to the user communication device 20.

At step 1003, the user communication device 20 can receive the search results report and can display the same to the user via the display device 20E of the communication device 20. In a preferred embodiment, the search results page can display a listing of any number of real estate assets of high value assets identified by the search. In a preferred embodiment, each listed real estate asset or each list high value asset can have a link or a hyperlink associated therewith which can allow the user to access the respective real estate asset profile of high value asset profile. At step 1003, the user can select the real estate asset or the high value asset for which he or she desires to obtain information, and can transmit the selection, or information regarding the selection, to the central processing computer 10.

In the preferred embodiment, the central processing computer 10 can, at step 1003, transmit the selected real estate asset profile, for or corresponding to the selected real estate asset, or the high value asset profile, for or corresponding to the selected high value asset, to the user communication device 20, and the selected real estate asset profile or the selected high value asset profile can be displayed and/or viewed by the user via the display device 20E. In a preferred embodiment, the selected real estate asset profile or the selected high value asset profile can be provided to, and/or viewed via, the user communication device 20 in or via an electronic forum, which electronic forum, in addition to allowing the user to view the selected real estate asset profile or the selected high value asset profile, can also allow the user to view and/or access any and/or all of the other information described herein as being provided via the electronic forum.

At step 1004, the user can gain access to and/or view information provided in the selected real estate asset profile or the selected high value asset profile and/or any other information described herein as being provided via the selected real estate asset profile or the selected high value asset profile or the electronic forum. In a preferred embodiment, the selected real estate asset profile or the selected high value asset profile can include information about the selected real estate asset profile or the selected high value asset profile, a description of same, photographs and/or pictures of same, a video presentation of or regarding the same, information regarding the owner, contact information for the owner, including, but not limited to, telephone number, videoconference identification information, cellular telephone number, text messaging or SMS messaging number or contact information, email address, and/or any other contact information for the owner, along with any information regarding the selected real estate asset or the selected high value asset which could be of interest to any prospective purchaser.

In a preferred embodiment, at step 1004, the user can also review any information regarding the real estate asset or the high value asset as provided in the selected real estate asset profile or the selected high value asset profile. The user can also view any pictures or photographs, and/or can view any video presentations of and/or for the real estate asset or the high value asset. In a preferred embodiment, the user can also view any video presentation as a 3-dimensional presentation, as a virtual reality (VR) presentation, or as an augmented reality (AR) presentation. At step 1004, the user can also request information from the owner or post a question for the owner of the real estate asset or the high value asset.

At step 1005, the user can also and thereafter perform any action or activity and/or any number of actions or activities while in the electronic forum. In a preferred embodiment, the electronic forum and the selected real estate asset profile or the selected high value asset profile can be presented in the form of a user dashboard and can contain or include a display of selected real estate asset profile or the selected high value asset profile. In the preferred embodiment, the electronic forum can be utilized to allow the user to register and/or enter information regarding his or her interest to purchase selected real estate asset or the selected high value asset and/or to present an offer to purchase the real estate asset or the selected high value asset. In the preferred embodiment, the offer can also include an offering price to purchase the real estate asset or the selected high value asset. In the preferred embodiment, the electronic forum can contain a link(s) or a hyperlink(s) which can allow the user to communicate with the owner of the selected real estate asset or the selected high value asset (hereinafter also referred to as “the owner”).

For example, in the preferred embodiment, the electronic forum or user dashboard can also contain information regarding, and/or a link or a hyperlink to or for, any one or more of allowing the user to telephone the owner's telephone and/or any other user communication device 20 associated with and/or utilized by the owner and engage in a telephone call with the owner, to engage in a video conference call with the owner via any user communication device 20 associated with and/or utilized by the owner, to transmit an email message to the owner, and/or to transmit a text message, and SMS message, or any other electronic message, to the owner. In this regard, at step 1005, the user can communicate with the owner, via the electronic forum and the user's user communication device 20, via any one or more of the links or hyperlinks and/or modes of communication described herein, ask questions of the owner, and/or inquire as to whether or not the selected real estate asset or the selected high value asset may be for sale and/or if the owner, appraised of an interest by the user to purchase the same, would consider selling the same.

In a preferred embodiment, the electronic forum or user dashboard can also contain information regarding, and/or a link or a hyperlink to or for, any one or more governmental entity computers 30, any one or more of the broker/agent communication devices 40, any one or more of the service provider communication devices 50, any one or more of the information/analytics provider computers 60, and/or any one or more of the financial institution computers 70. At step 1005, the user can also utilize information and/or any one of more of any of the various provided links or hyperlinks to communicate with, request or obtain information from, purchase respective products and/or services from, and/or engage, any governmental entity associated with a selected governmental entity computer 30, any broker or agent associated with a selected broker/agent communication device 40, any service provider associated with a selected service provider communication device 50, any information/analytics provider associated with a selected information/analytics provider computer 60, and/or any financial institution associated with a selected financial institution computer 70.

For example, at step 1005, the user can contact and/or link to a governmental entity in which the selected real estate asset is located, via a link or hyperlink to the governmental entity computer 30 associated with the governmental entity, in order to inquire as to property tax information, information regarding certificates of occupancy, building permits, and/or any other information of interest to a purchaser of a real estate asset, and/or in order to purchase a copies or copies of a survey, a deed, a blueprint or a floor plan, an inspection report, and/or any other document, on file with the governmental entity for or regarding the real estate asset. In the case of a high value asset, the user can contact the governmental entity in order to inquire as any information regarding the high value asset which may be obtained from the governmental entity, and/or in order to purchase a copy or copies of any document(s) on file with the governmental entity regarding or pertaining to the high value asset. In this regard, the apparatus 100 allows a user to directly contact, via the user communication device 20, the central processing computer 10, and/or the electronic forum, the governmental entity in order to obtain information and/or documents.

At step 1005, the user can also contact and/or link to a broker or an agent, via a link or hyperlink to the broker/agent communication device 40 associated with the broker or the agent, in order to obtain information regarding the selected real estate asset or the selected high value asset, or the purchasing of the same, and/or in order to engage the services of the broker or the agent for purposes to purchasing the selected or another real estate asset or the selected or another high value asset. In this regard, the apparatus 100 allows a user to directly contact, via the user communication device 20, the central processing computer 10, and/or the electronic forum, a broker or agent for assistance in purchasing the selected or another real estate asset or the selected or another high value asset.

At step 1005, the user can also contact and/or link to a service provider, via a link or hyperlink to the service provider communication device 50 associated with the service provider, in order to obtain information regarding any services and/or goods provided by the service provider, which may be useful for and/or needed by the user in purchasing and/or in owning the selected real estate asset or the selected high value asset, and/or in order to engage the services of the service provider and/or purchase goods and/or services from the services provider. For example, the service provider can be an attorney, an engineer, an architect, a home improvement professional, a contractor, a mechanic, or any other service provider. In this regard, the apparatus 100 allows a user to directly contact, via the user communication device 20, the central processing computer 10, and/or the electronic forum, a service provider in order to obtain information and/or to engage the services of service provider.

At step 1005, the user can also contact and/or link to an information and/or analytics provider, via a link or hyperlink to the information/analytics provider computer 60 associated with the information and/or analytics provider, in order to obtain information regarding the selected real estate asset or the selected high value asset and/or the market for the same, such as, for example, but not limited to, valuation information, demand information, market information, comparable value information, and/or any other data and/or information which can be helpful or useful to the user. In this regard, the apparatus 100 allows a user to directly contact, via the user communication device 20, the central processing computer 10, and/or the electronic forum, an information and/or analytics provider in order to obtain information from the same.

At step 1005, the user can also contact and/or link to a financial institution, via a link or hyperlink to the financial institution computer 70 associated with the financial institution, in order to obtain information regarding the financial products and/or services, and/or mortgages or loans, provided by the financial institution, and/or in order to apply for a mortgage or a loan for or regarding the selected real estate asset or the selected high value asset, and/or in order to obtain any other data and/or information which can be helpful or useful to the owner. In this regard, the apparatus 100 allows a user to directly contact, via the user communication device 20, the central processing computer 10, and/or the electronic forum, a financial institution in order to obtain information from the same, apply for a mortgage or a loan, and/or for any other reason or purpose.

In a preferred embodiment, the electronic forum can also provide identifying information, a name, an address, a telephone number, a website address or url, an email address, and/or any other information for or regarding any relevant or pertinent governmental entity or governmental entities associated with the selected real estate asset or the selected high value asset, along with a link to its governmental entity computer 30, and/or any available brokers or agents associated with a broker/agent communication device 40, any service provider associated with a service provider computer 50, any information or analytics providers associated with an information/analytics provider computer 60, and/or any financial institution associated with a financial institution computer 70.

In a preferred embodiment, at step 1005, the user can also post any information, post any purchase offer, and/or perform any other action or activity, with the selected real estate asset profile or the selected high value asset profile and/or with or within the electronic forum, and via the user communication device 20, while also having access to the selected real estate asset profile or the selected high value asset profile. In a preferred embodiment, once the user has completed performing any actions and/or activities in or within the electronic forum and/or with regards to the selected real estate asset profile or the selected high value asset profile, the central processing computer 10 will, at step 1006, store, in the database 10H, any information regarding any registered or indicated interest in the selected real estate asset or the selected high value asset by the user, any purchase price offered by the user for the selected real estate asset or the selected high value asset, and/or any other information regarding any actions or activities taken by the user regarding selected real estate asset profile or the selected high value asset profile.

At step 1007, the central processing computer 10 will process any data and/or information entered by the user at step 1005 and/or stored by the central processing computer 10 at step 1006, determine if any alert messages or notification messages are to be generated and transmitted to the owner of the selected real estate asset or the selected high value asset, and/or to any other users. If any alert messages or notification messages are to be generated by and transmitted from the central processing computer 10, then the central processing computer 10 can generate any needed alert message(s) or notification message(s) and transmit the same to the owner and/or as a text message, an SMS message, an instant message, and/an electronic communication transmission, to any user communication device 20 associated with the owner, and/or as an email message transmitted to an email server associated with the owner, and/or the central processing computer 10 can generate any needed alert message(s) or notification message(s) and transmit the same to any other user and/or as a text message, an SMS message, an instant message, and/an electronic communication transmission, to any user communication device 20 associated with the other user, and/or as an email message transmitted to an email server associated with the other user. In a preferred embodiment, any alert messages or notifications messages can also be stored by the central processing computer 10 in the database 10H and/or in any user profile or record associated with the owner of the real estate asset or the high value asset and/or in any user profile or record associated with the other user.

At step 1008, the user can decide to exit the electronic forum and the central processing computer 10 or the user can decide to return to the search results page. If, step 1008, the user decides to return to the search results page, then the operation of the apparatus will return to step 1003 and the above described process can be repeated. If, at step 1008, the user decides to exit the electronic forum and the central processing computer 10, then the operation of the apparatus 100 will cease at step 1009.

Any data and/or information, and/or any software applications, needed or desired for enabling the apparatus 100 of the present invention to operate as described in the embodiment of FIGS. 10A and 10B can be stored in the database 10H, and/or in any of the other databases 20H, 30H, 40H, 50H, 60H, and/or 70H, described herein.

In another preferred embodiment, the apparatus 100 of FIGS. 10A and 10B can be utilized in a same, a similar, and/or an analogous manner, by a prospective renter or lessee to indicate an interest in renting or leasing a real estate asset or a high value asset.

In another preferred embodiment, any user who is an owner (hereinafter also referred to as “owner/user”) of a real estate asset or multiple real estate assets and/or a high value asset or multiple high values assets can utilize the apparatus 100 and methods of the present invention in order to monitor interest in his, her, or its, respective real estate asset(s) or high value asset(s), provide or upload information to the respective real estate asset profile or high value asset profile, and/or engage in any action or activity regarding his, her, or its, respective real estate asset or real estate asset profile or high value asset or high value asset profile. These actions or activities can include, but are not limited to, updating information in his, her, or its, respective real estate asset profile or high value asset profile, uploading documents, information, and/or video presentations of any type or kind to the respective real estate asset profile or high value asset for retrieval by any other user, and/or communicate with any user or users, request to be notified if and/or when a user or prospective purchaser registers or indicates an interest in, or make an offer to purchase, his, her, or its, respective real estate or high value asset, request to be notified if and/or when a user or prospective purchaser, who is pre-qualified for a loan of a certain amount, registers or indicates an interest in, or make an offer to purchase, his, her, or its, respective real estate or high value asset, request to be notified when any user or prospective purchaser, or any specific user or prospective purchaser views, and/or performs any action or activities regarding or pertaining to, his, her, or its, respective real estate profile or high value asset profile, and/or request to be notified upon the occurrence of any other specified event which may be of interest to the owner or to any user interested in the owner's respective real estate or real estate profile or high value asset or high value asset profile.

The owner/user can also access any one or more of any one or more of the user communication device 20 of any other user, any one or more of the governmental entity computers 30, any one or more of the broker/agent communication devices 40, any one or more of the service provider communication devices 50, any one or more of the information/analytics provider computers 60, and/or any one or more of the financial institution computers 70, in order to obtain information from the respective user, governmental entity, broker/agent, service provider, information/analytics provider, and/or financial institution. The owner/user can also request information from the central processing computer 10 at any time. Thereafter, any alert message(s) or notification message(s) which may be generated based on the owner/user actions or activities, can be generated and/or transmitted to the user communication devices 20 of any and/or all users who or which requested receiving such alert message(s) or notification message(s). Thereafter, the central processing computer 10 can store, in the database 10H, any and/or all information regarding the owner/user's use of the apparatus 100 and/or any action or activity taken by the owner/user regarding or pertaining to his, her, or its, respective real estate asset or real estate asset profile or high value asset or high value asset profile, and/or store information regarding any and/or all alert message(s) or notification message(s) transmitted by the central processing computer 10. Thereafter, the operation of the apparatus 100 can cease.

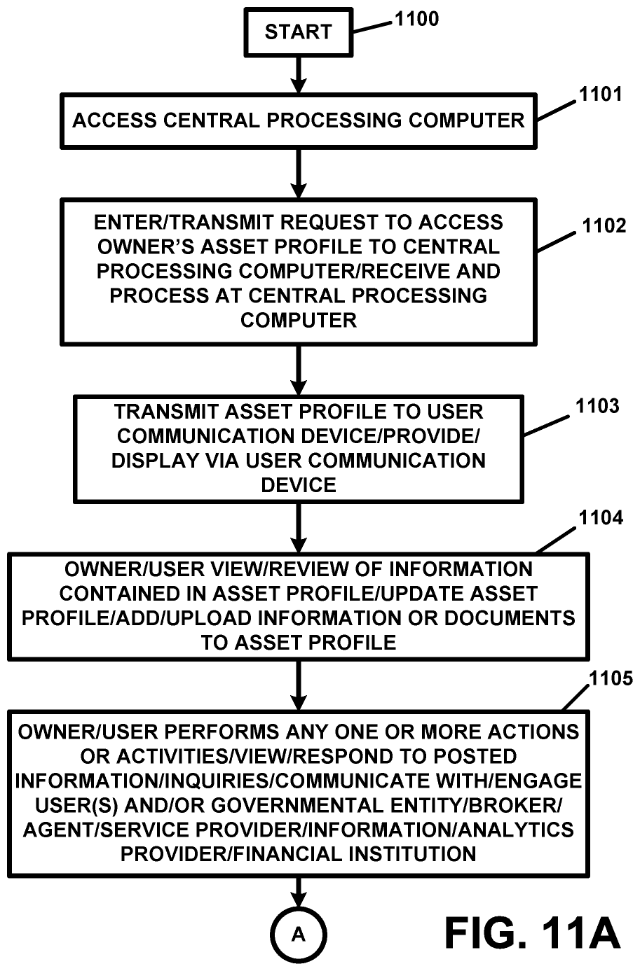

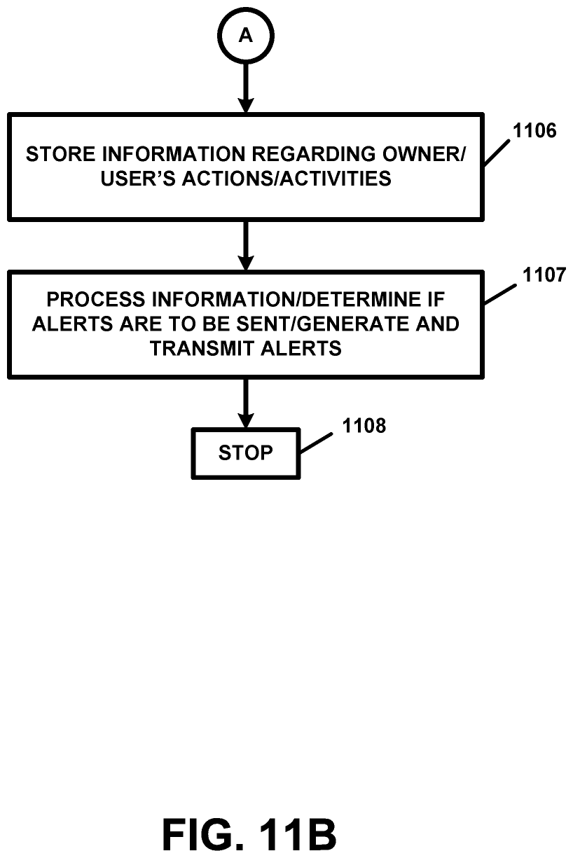

FIGS. 11A and 11B illustrate another preferred embodiment method for utilizing the apparatus 100 and methods of the present invention, in flow diagram form. With reference to FIGS. 11A and 11B, the operation of the apparatus 100 commences at step 1100. At step 1101, the owner/user can access the central processing computer 10 with or using his or her user communication device 20. At step 1102, the owner/user can request to access the real estate asset profile or the high value asset profile for his or her respective real estate asset or the high value asset. In another preferred embodiment, each owner/user can have any real estate asset profile(s) or high value asset profile(s) linked to, and/or accessible via, his or her user profile. In a preferred embodiment, at step 1102, the owner/user can use his or her user communication device 20 to request to access his or her real estate asset profile or high value asset profile by searching for same or by linking to same from his or her user profile. At step 1102, the owner/user's request to access his or her real estate asset profile or high value asset profile can be transmitted to, and received at or by, the central processing computer 10. At step 1102, the central processing computer 10 can receive and process information regarding the owner's request to access his or her real estate asset profile or high value asset profile.

At step 1103, the central processing computer can transmit, and the user communication device 20 can receive, the real estate asset profile or the high value asset profile and the same can be provided to or displayed to the owner/user via the display device 20E of the communication device 20. In a preferred embodiment, the real estate asset profile or the high value asset profile can be provided to, and/or can be displayed via, the user communication device 20 in an electronic forum, which electronic forum, in addition to allowing the owner/user to view and/or update the real estate asset profile or the high value asset profile, can also allow the owner/user to view and/or access any and/or all of the other information described herein as being provided via the electronic forum, and/or can also allow the owner/user to communicate and/or engage with any other user and/or to communicate and/or engage with any governmental entity, broker or agent, service provider, information and/or analytics provider, and/or financial institution.

At step 1104, the owner/user can view, review, and/or update any information provided in his or her real estate asset profile or the high value asset profile and/or any other information described herein as being provided via the selected real estate asset profile or the selected high value asset profile or the electronic forum. In a preferred embodiment, the real estate asset profile or the high value asset profile can include information about the real estate asset or the high value asset, a description of same, photographs and/or pictures of same, a video presentation of or regarding the same, information regarding the owner, contact information for the owner, including, but not limited to, telephone number, videoconference identification information, cellular telephone number, text messaging or SMS messaging number or contact information, email address, and/or any other contact information for the owner, along with any information regarding the selected real estate asset or the selected high value asset which would be of interest to a prospective purchaser.

In a preferred embodiment, the real estate asset profile or the high value asset profile can include information about any user(s) who or which has registered or otherwise indicated an interest in purchasing the real estate asset or the high value asset, along with their name(s), contact information, including, but not limited to, telephone number, videoconference identification information, cellular telephone number, text messaging or SMS messaging number or contact information, email address, and/or any other contact information for the user, along with any other information regarding user which could be of interest to the seller.

In a preferred embodiment, at step 1104, the owner/user can also review and/or update any information regarding the real estate asset or the high value asset as provided in the real estate asset profile or the high value asset profile. The owner/user can also, at step 1104, upload to, and store in, the real estate asset profile or the high value asset profile, any document(s), such as, for example, but not limited to, a copy of a blue print or floor plan, an inspection report, a survey, a receipt(s) evidencing repairs or renovations, a building permit(s), a certificate of occupancy, a title report, a title document, a deed, a tax bill(s), a utility bill(s), real estate contract for use in selling the real estate asset, and/or an appraisal, and/or any other document and/or information, for or regarding the real estate asset, or any document, such as, for example, but not limited to, a copy of a bill of sale, a certificate or authenticity, a repair bill(s), a title document, and/or any other document, for or regarding the high value asset. At step 1104, the owner/user can also upload any pictures or photographs, and/or any video presentations of and/or for the real estate asset or the high value asset. In a preferred embodiment, the user can also upload any 3-dimensional video presentation, any virtual reality (VR) presentation, or any augmented reality (AR) presentation.

At step 1105, the owner/user can also and thereafter perform any action or activity and/or any number of actions or activities while in the electronic forum. In a preferred embodiment, the electronic forum and the real estate asset profile or the high value asset profile can be presented in the form of an owner/user dashboard and can contain or include a display of real estate asset profile or the high value asset profile. In the preferred embodiment, the electronic forum can be utilized to allow the owner/user to view any information regarding any user or users who or which have expressed an interest in purchasing, and/or who have made an purchase offer for the real estate asset or the high vale asset and/or to allow the owner/user address and/or respond to any request(s) for information or any question(s) previously posted by any user regarding the real estate asset or high value asset. At step 1105, the owner/user can address or respond to any request(s) for information or any question(s) by posting an answer to same and/or by uploading a document(s) which addresses or is responsive to same.

In the preferred embodiment, the electronic forum can contain a link(s) or a hyperlink(s) which can allow the owner/user to communicate with each user who or which has registered or indicated an interest in purchasing the real estate asset or the high value asset (hereinafter also referred to as “interested user”). For example, in the preferred embodiment, the electronic forum or user dashboard can also contain information regarding, and/or a link or a hyperlink to or for, any one or more of allowing the owner/user, for any interested user, to telephone the interested user's telephone and/or any other user communication device 20 associated with and/or utilized by the interested user and engage in a telephone call with the interested user, to engage in a video conference call with the interested user via any user communication device 20 associated with and/or utilized by the interested user, to transmit an email message to the interested user, and/or to transmit a text message, and SMS message, or any other electronic message, to the interested user. In this regard, at step 1105, the owner/user can communicate with any interested user or any number of interested users while in the electronic forum, and via the electronic forum and the owner/user's user communication device 20, and via any one or more of the links or hyperlinks and/or modes of communication described herein, ask questions of the interested user, and/or address any inquiries by any interested user regarding the real estate asset or the high value asset.

In a preferred embodiment, the electronic forum or the dashboard can also contain information regarding, and/or a link or a hyperlink to or for, any one or more governmental entity computers 30, any one or more of the broker/agent communication devices 40, any one or more of the service provider communication devices 50, any one or more of the information/analytics provider computers 60, and/or any one or more of the financial institution computers 70. At step 1105, the owner/user can also utilize information and/or any one of more of the various provided links or hyperlinks to communicate with, request or obtain information from, purchase respective products and/or services from, and/or engage, any governmental entity associated with a selected governmental entity computer 30, any broker or agent associated with a selected broker/agent communication device 40, any service provider associated with a selected service provider communication device 50, any information/analytics provider associated with a selected information/analytics provider computer 60, and/or any financial institution associated with a selected financial institution computer 70.

For example, at step 1105, the owner/user can contact and/or link to a governmental entity in which the selected real estate asset is located, via a link or hyperlink to the governmental entity computer 30 associated with the governmental entity, in order to inquire as to property tax information, information regarding certificates of occupancy, building permits, and/or any other information of interest to a seller of a real estate asset, and/or in order to purchase a copies or copies of a survey, a deed, a blueprint or a floor plan, an inspection report, and/or any other document, on file with the governmental entity for or regarding the real estate asset. In the case of a high value asset, the owner/user can contact the governmental entity in order to inquire as to any information regarding the high value asset which may be obtained from the governmental entity, and/or in order to purchase a copy or copies of any document(s) on file with the governmental entity regarding or pertaining to the high value asset. In this regard, the apparatus 100 allows an owner/user to directly contact, via the user communication device 20, the central processing computer 10, and/or the electronic forum, the governmental entity in order to obtain information and/or documents.

At step 1105, the user can also contact and/or link to a broker or an agent, via a link or hyperlink to the broker/agent communication device 40 associated with the broker or the agent, in order to obtain information regarding his or her real estate asset or high value asset, or the selling of the same, and/or in order to engage the services of the broker or the agent for purposes to selling his or her real estate asset or high value asset. In this regard, the apparatus 100 allows a user to directly contact, via the user communication device 20, the central processing computer 10, and/or the electronic forum, a broker or agent for obtaining assistance in selling the real estate asset or the high value asset.

At step 1105, the owner/user can also contact and/or link to a service provider, via a link or hyperlink to the service provider communication device 50 associated with the service provider, in order to obtain information regarding any services and/or goods provided by the service provider, which may be useful for and/or needed by the owner/user in selling his or her real estate asset or high value asset, and/or in order to engage the services of the service provider and/or purchase goods and/or services from the service provider. For example, the service provider can be an attorney, an engineer, an architect, a home improvement professional, a contractor, a mechanic, or any other service provider. In this regard, the apparatus 100 allows an owner/user to directly contact, via the user communication device 20, the central processing computer 10, and/or the electronic forum, a service provider in order to obtain information and/or to engage the services of service provider.

At step 1105, the owner/user can also contact and/or link to an information and/or analytics provider, via a link or hyperlink to the information/analytics provider computer 60 associated with the information and/or analytics provider, in order to obtain information regarding his or her real estate asset or high value asset and/or the market for the same, such as, for example, but not limited to, valuation information, demand information, market information, comparable value information, and/or any other data and/or information which can be helpful or useful to the owner/user. In this regard, the apparatus 100 allows a user to directly contact, via the user communication device 20, the central processing computer 10, and/or the electronic forum, an information and/or analytics provider in order to obtain information from the same.

At step 1105, the owner/user can also contact and/or link to a financial institution, via a link or hyperlink to the financial institution computer 70 associated with the financial institution, in order to obtain information regarding the financial products and/or services, and/or mortgages or loans, provided by the financial institution, and/or in order to apply for a mortgage or a loan for or regarding the selected real estate asset or the selected high value asset, to ascertain any balance(s) remaining on any mortgage(s) or other loans(s) on the real estate asset or high value asset, and/or in order to obtain any other data and/or information which can be helpful or useful to the owner. In this regard, the apparatus 100 allows a user to directly contact, via the user communication device 20, the central processing computer 10, and/or the electronic forum, a financial institution in order to obtain any information from the same, apply for a mortgage or a loan, and/or for any other reason or purpose.

In a preferred embodiment, the electronic forum can also provide identifying information, a name, an address, a telephone number, a website address or url, an email address, and/or any other information for or regarding any relevant or pertinent governmental entity or governmental entities associated with the selected real estate asset or the selected high value asset, along with a link to its governmental entity computer 30, and/or any available brokers or agents associated with a broker/agent communication device 40, any service provider associated with a service provider computer 50, any information or analytics providers associated with an information/analytics provider computer 60, and/or any financial institution associated with a financial institution computer 70.

In a preferred embodiment, at step 1105, the owner/user can also post any information, list the real estate asset or high value asset for sale, post an asking price for an offer to sell the real estate asset or high value asset, post a change to an asking price for an offer to sell the real estate asset or high value asset, and/or post any other information regarding his or her real estate asset or high value asset, and/or perform any other action or activity, with the real estate asset profile or the high value asset profile and/or with or within the electronic forum, and via the user communication device 20, while having access to the real estate asset profile or the high value asset profile. In a preferred embodiment, once the owner/user has completed performing any actions and/or activities in or within the electronic forum and/or with regards to the real estate asset profile or the high value asset profile, the central processing computer 10 can, at step 1106, store, in the database 10H, any information regarding any of the herein-described and/or any other actions or activities undertaken by the owner/user at step 1105 and/or can store any other information regarding any actions or activities taken by the owner/user regarding the real estate asset profile or the high value asset profile.

At step 1107, the central processing computer 10 can process any data and/or information entered by the owner/user at step 1105 and/or stored by the central processing computer 10 at step 1106, determine if any alert messages or notification messages are to be generated and transmitted to any user or users for or regarding the real estate asset or the high value asset. If any alert messages or notification messages are to be generated by and transmitted from the central processing computer 10, then the central processing computer 10 can, at step 1107 generate any needed alert message(s) or notification message(s) and transmit the same to the user or users as a text message, an SMS message, an instant message, and/or an electronic communication transmission, to user communication device(s) 20 associated with the respective user(s), and/or as an email message transmitted to an email server(s) associated with respective user(s). In a preferred embodiment, any alert messages or notifications messages can also be stored by the central processing computer 10 in the database 10H and/or in any user profile or record associated with a user. Thereafter, the owner/user can exit the electronic forum and the operation of the apparatus will cease at step 1108.

Any data and/or information, and/or any software applications, needed or desired for enabling the apparatus 100 of the present invention to operate as described in the embodiment of FIGS. 11A and 11B can be stored in the database 10H, and/or in any of the other databases 20H, 30H, 40H, 50H, 60H, and/or 70H, described herein.

Further, any data and/or information, and/or any software applications, needed or desired for enabling the apparatus 100 of the present invention to operate as described in the any and/or all of the embodiment described herein can be also be stored in the database 10H, and/or in any of the other databases 20H, 30H, 40H, 50H, 60H, and/or 70H, described herein.

In another preferred embodiment, the apparatus 100 of FIGS. 11A and 11B can be utilized in a same, a similar, and/or an analogous manner, by a prospective renter or lessee to indicate an interest in renting or leasing a real estate asset or a high value asset.

In any and/or all of the embodiments described herein, the electronic forum can also be replaced by or with any suitable webpage or webpage design, any suitable chat room, or any other design and/or any other suitable media entity which can provide any and/or all of the herein-described information, presentations, and/or links or hyperlinks, described herein as being provided or presented to any of the herein-described users or an owner/users.

In the above-described manner, the apparatus 100 can allow any user to search for and/or identify any real estate asset and/or any high value asset, whether or not the same is currently being offered for sale, and take any step or perform any action or activity in seeking to purchase the same. In this regard, the apparatus 100 of the present invention can be used to allow a user to expand his or her universe of real estate assets and/or high value assets from among which he or she may be able to shop and/or effectuate a purchase while, at the same time, providing an owner of a real estate asset or a high value asset with information regarding current market demand, and/or current market value, for his, her, or its, real estate asset or a high value asset.

In the above-described the manner, the electronic forums and/or real estate asset profiles and/or high value asset profiles, described herein, can provide any user and/or with any and/or all information and/or contact information needed, required, or desired, for allowing the user to search for, and to make a fully informed decision when seeking to purchase a real estate asset or a high value asset. In the above-described the manner, the electronic forums and/or real estate asset profiles and/or high value asset profiles, described herein, can also provide any owner of any real estate asset or high value asset with any and/or all information and/or contact information needed, required, or desired, for allowing the owner to make a fully informed decision when deciding whether or not to sell a real estate asset or a high value asset.

In the above-described manner, the apparatus 100 and methods of the present invention overcomes a number of shortfalls in conventional systems for selling and/or marketing real estate assets and/or high value assets and represents a substantial technological improvement over conventional systems.

The apparatus 100 and methods of the present invention can provide an owner of a real estate asset or a high value asset with information regarding any interest by a prospective purchaser to purchase the same at any time and regardless of whether or not the owner's real estate asset or high value asset is currently listed, or is currently being offered, for sale. In this regard, the apparatus 100 and methods of the present invention can provide an owner of a real estate asset or a high value asset with current information regarding the demand and/or market value for his or her real estate asset or high value asset at any time.

The apparatus 100 and methods of the present invention can also provide any user or prospective purchaser of a real estate asset or a high value asset with the opportunity to express interest in purchasing, and/or make an offer to purchase, any real estate asset or a high value asset regardless of whether or not the real estate asset or high value asset is currently listed, or is currently being offered for sale. In this regard, the apparatus 100 and methods of the present invention can also provide a user or prospective purchaser of a real estate asset or a high value asset with a larger universe of real estate assets or high value assets from which to choose when making purchasing decisions.

In any and/or all of the embodiments described herein, any data and/or information and/or any transactions or communications, for, regarding, relating, or pertaining, to any of the herein-described user profiles, real estate asset profiles, and/or high value asset profiles, and/or any offers made by any users for any real estate assets and/or any high value assets, and/or any other information and/or communications, including contracts for sale for any of the herein-described real estate assets and/or high value assets and/or any documents relating or pertaining to any of the herein-described real estate assets and/or high value assets, can be processed and/or stored using a distributed ledger and blockchain technology or blockchain technologies.

Applicant incorporates by reference herein the subject matter and teachings of “Blockchain Technology Explained” by Alan T. Norman, “Blockchain” by Abraham K. White, “Blockchain—A Practical Guide To Developing Business, Law, And Technology Solutions” by Joseph J. Bambara and Paul R. Allen, and “Blockchain—Ultimate Guide To Understanding Blockchain, Bitcoin, Cryptocurrencies, Smart Contracts And The Future of Money” by Mark Gates, in their entirety, for all of their respective subject matter and teachings regarding distributed ledger technology and/or technologies, Blockchain technology and/or technologies, Bitcoin technology and/or technologies, Bitcoin Blockchain technology and/or technologies, Ethereum technology and/or technologies, Ethereum Blockchain technology and/or technologies, cryptocurrencies, cryptocurrency technology and/or technologies, and/or smart contract technology and/or technologies, and/or decentralized autonomous organizations (DAOs) technologies, and/or peer-to-peer technology and/or technologies, and/or any other technology or technologies related thereto or which can be utilized in conjunction distributed ledgers, Blockchain technologies, Smart contracts, decentralized autonomous organizations (DAOs), and/or cryptocurrencies.

In any and/or all of the embodiments described herein, the apparatus 100 and methods of the present invention can also be utilized to facilitate the rental or leasing of any of the herein-described real estate assets and/or high value assets. In this manner, users can seek to rent or lease a real estate asset or a high value asset which may not be currently listed for rental or listed as being available for a lease, while also allowing an owner of a real estate asset or a high value asset to be apprised of an interest by a user or users to rent or lease his or her real estate asset or a high value asset and/or any market demand relating to the same.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus, comprising:
a database, wherein the database stores information regarding a plurality of user profiles, wherein each of the plurality of user profiles is associated with a user, a plurality of real estate asset profiles or a plurality of high value asset profiles, wherein each of the plurality of real estate asset profiles is associated with a real estate asset of an owner or each of the plurality of high value asset profiles is associated with a high value asset of an owner, and information regarding real estate assets of public record, real estate assets offered for sale, high value assets of public record, or high value assets offered for sale;
a receiver, wherein the receiver receives a request to access a real estate asset profile or a high value asset profile, wherein the request to access a real estate asset profile or a high value asset profile is transmitted from a communication device associated with the user;
a processor, wherein the processor processes the request to access a real estate asset profile or a high value asset profile; and
a transmitter, wherein the transmitter transmits the real estate asset profile or the high value asset profile and contact information for the owner of the real estate asset or the high value asset, a governmental entity, a broker or agent, a service provider, an information or analytics provider, or a financial institution, to the communication device,
wherein the communication device provides or displays an electronic forum or a webpage containing the real estate asset profile or the high value asset profile and the contact information for the owner of the real estate asset or the high value asset, a governmental entity, a broker or agent, a service provider, an information or analytics provider, or a financial institution,
wherein the receiver receives information, transmitted from the communication device, regarding an interest by the user in purchasing the real estate asset or the high value asset or an offer by the user to purchase the real estate asset or the high value asset, and further wherein the information regarding the interest by the user in purchasing the real estate asset or the high value asset or the offer by the user to purchase the real estate asset or the high value asset is stored in the database and in the real estate asset profile or the high value asset profile,
wherein the contact information for the owner of the real estate asset or the high value asset, a governmental entity, a broker or agent, a service provider, an information or analytics provider, or a financial institution, is displayed via the electronic forum or the webpage,
wherein the apparatus stores, in the database, information regarding an action or an activity of the user regarding the real estate asset, the real estate asset profile, the high value asset, or the high value asset profile.

2. The apparatus of claim 1, wherein the real estate asset profile of the high value asset profile contains a picture, a photograph, or a video presentation, of or regarding the real estate asset or the high value asset.

3. The apparatus of claim 2, wherein the video presentation contains 3-dimensional video information, virtual reality video information, or augmented reality video information.

4. The apparatus of claim 1, wherein the apparatus receives information for creating a user profile, wherein the information for creating the user profile is transmitted from the communication device or from a second communication device, and further wherein the apparatus creates the user profile and stores the user profile in the database.

5. The apparatus of claim 1, wherein the apparatus receives information for editing or updating a user profile, wherein the apparatus updates the user profile and stored the user profile in the database.

6. The apparatus of claim 1, wherein the apparatus receives a request transmitted from a second communication device associated with the owner of the real estate asset or the high value asset to access the real estate asset profile for the real estate asset or the high value asset profile for the high value asset, wherein the apparatus receives information transmitted from the second communication device to update information in the real estate asset profile or the high value asset profile, and further wherein the apparatus updates and stores the real estate asset profile or the high value asset profile.

7. The apparatus of claim 1, wherein the apparatus receives a request transmitted from a second communication device associated with the owner of the real estate asset or the high value asset to access the real estate asset profile for the real estate asset or the high value asset profile for the high value asset, wherein the apparatus receives a document regarding the real estate asset or the high value asset or a link or a hyperlink to a document regarding the real estate asset or the high value asset, and
and further wherein the apparatus updates the real estate asset profile or the high value asset profile to include the document regarding the real estate asset or the high value asset or the link or the hyperlink to a document regarding the real estate asset or the high value asset.

8. The apparatus of claim 1, wherein the apparatus facilitates a telephone call or a video conference between the user and the owner.

9. The apparatus of claim 1, wherein the apparatus stores information regarding the real estate asset, the real estate asset profile, the high value asset, or the high value asset profile, using a distributed ledger and a blockchain technology.

10. The apparatus of claim 1, wherein the processor or the apparatus generates an alert message containing information regarding the interest by the user in purchasing the real estate asset or the high value asset or an offer by the user to purchase the real estate asset or the high value asset, or containing information regarding an action or an activity by the user regarding the real estate asset, the real estate asset profile, the high value asset, of the high value asset profile, and further wherein the apparatus transmits the alert message to a second communication device, wherein the second communication device is associated with the owner of the real estate asset or the high value asset or the second communication device is associated with a second user.

11. The apparatus of claim 1, wherein the contact information for the owner of the real estate asset or the high value asset, the governmental entity, the broker or agent, the service provider, the information or analytics provider, or the financial institution, includes a link or a hyperlink to a second communication device or to a computer, wherein the second communication device or the computer is associated with the owner, the governmental entity, the broker or agent, the service provider, the information or analytics provider, or the financial institution.

12. A computer-implemented method, comprising:
storing, in a database, information regarding a plurality of user profiles, wherein each of the plurality of user profiles is associated with a user, a plurality of real estate asset profiles or a plurality of high value asset profiles, wherein each of the plurality of real estate asset profiles is associated with a real estate asset of an owner or each of the plurality of high value asset profiles is associated with a high value asset of an owner, and information regarding real estate assets of public record, real estate assets offered for sale, high value assets of public record, or high value assets offered for sale; receiving, with a receiver, a request to access a real estate asset profile or a high value asset profile, wherein the request to access a real estate asset profile or a high value asset profile is transmitted from a communication device associated with the user;
processing, with a processor, the request to access a real estate asset profile or a high value asset profile;
transmitting, from a transmitter, the real estate asset profile or the high value asset profile and contact information for the owner of the real estate asset or the high value asset, a governmental entity, a broker or agent, a service provider, an information or analytics provider, or a financial institution, to the communication device,
providing or displaying, at or via the communication device, an electronic forum or a webpage containing the real estate asset profile or the high value asset profile and the contact information for the owner of the real estate asset or the high value asset, a governmental entity, a broker or agent, a service provider, an information or analytics provider, or a financial institution, wherein the contact information for the owner of the real estate asset or the high value asset, a governmental entity, a broker or agent, a service provider, an information or analytics provider, or a financial institution, is displayed via the electronic forum or the webpage;
receiving information, transmitted from the communication device, regarding an interest by the user in purchasing the real estate asset or the high value asset or an offer by the user to purchase the real estate asset or the high value asset;
storing, in the database, the information regarding the interest by the user in purchasing the real estate asset or the high value asset or the offer by the user to purchase the real estate asset or the high value asset; and
storing, in the database, information regarding an action or an activity of the user regarding the real estate asset, the real estate asset profile, the high value asset, or the high value asset profile.

13. The computer-implemented method of claim 12, wherein the real estate asset profile of the high value asset provide contains a picture, a photograph, or a video presentation, of or regarding the real estate asset or the high value asset.

14. The computer-implemented method of claim 13, wherein the video presentation contains 3-dimensional video information, virtual reality video information, or augmented reality video information.

15. The computer-implemented method of claim 12, further comprising:
receiving information for creating a user profile, wherein the information for creating the user profile is transmitted from the communication device or from a second communication device;
creating the user profile; and
storing the user profile.

16. The computer-implemented method of claim 12, further comprising:
receiving information for editing or updating a user profile;
updating the user profile; and
storing the user profile.

17. The computer-implemented method of claim 12, further comprising:
receiving a request transmitted from a second communication device associated with the owner of the real estate asset or the high value asset to access the real estate asset profile for the real estate asset or the high value asset profile for the high value asset;
receiving information to update information in the real estate asset profile or the high value asset profile;
updating the real estate asset profile or the high value asset profile; and
storing the real estate asset profile or the high value asset profile.

18. The computer-implemented method of claim 12, further comprising:
receiving a request transmitted from a second communication device associated with the owner of the real estate asset or the high value asset to access the real estate asset profile for the real estate asset or the high value asset profile for the high value asset;
receiving a document regarding the real estate asset or the high value asset or a link or a hyperlink to a document regarding the real estate asset or the high value asset; and
updating the real estate asset profile or the high value asset profile to include the document regarding the real estate asset or the high value asset or the link or the hyperlink to a document regarding the real estate asset or the high value asset.

19. The computer-implemented method of claim 12, further comprising:
facilitating a telephone call or a video conference between the user and the owner.

20. The computer-implemented method of claim 12, further comprising: 10.
generating an alert message containing information regarding the interest by the user in purchasing the real estate asset or the high value asset or an offer by the user to purchase the real estate asset or the high value asset, or containing information regarding an action or an activity by the user regarding the real estate asset, the real estate asset profile, the high value asset, of the high value asset profile; and
transmitting the alert message to a second communication device, wherein the second communication device is associated with the owner of the real estate asset or the high value asset or the second communication device is associated with a second user.
